(19) United States
(12) Patent Application Publication
(10) Pub. No.: US 2015/0088770 A1
(43) Pub. Date: Mar. 26, 2015

(54) SYSTEMS AND METHODS FOR REDUCING THE UNAUTHORIZED RESALE OF EVENT TICKETS

(71) Applicant: Fair Ticket Solutions, Inc., Wilmington, DE (US)

(72) Inventors: Alan Gelfand, Vancouver (CA); Martin Ortmayr, N. Vancouver (CA); Kevin Peng, N. Vancouver (CA); Todd Edmondson, Port Moody (CA)

(73) Assignee: Fair Ticket Solutions, Inc.

(21) Appl. No.: 14/557,364

(22) Filed: Dec. 1, 2014

Related U.S. Application Data
(63) Continuation of application No. 13/386,377, filed on Apr. 5, 2012, now abandoned.
(60) Provisional application No. 61/349,993, filed on May 31, 2010.
(60) Provisional application No. 61/227,181, filed on Jul. 21, 2009.

(51) Int. Cl. G06Q 30/00

(52) U.S. Cl. CPC G06Q 30/0185
USPC 705/318

(57) ABSTRACT

The present invention relates to (a) a ticket management system for purchasing and allocating event tickets; (b) a ticket authentication system for authenticating tickets presented at an event; and (c) a secondary market system for the authorized resale of event tickets. These systems, individually and collectively, facilitate the reduction of ticket scalping by requiring the production of valid registered valued identification for the purchase, allocation, and resale of event tickets and the admittance to an event.

### FIELD OF INVENTION

The present invention relates to systems and methods for reducing the unauthorized sale of event tickets, and more particularly to a system and method for managing the sale, resale, and authentication of event tickets.

### BACKGROUND OF INVENTION

The unauthorized resale or “scalping” of event tickets in secondary markets poses substantial risks and disadvantages to consumers, original ticket vendors, and event organizers, namely: the purchase of tickets by ticket scalpers denies consumers the ability to purchase tickets at face value and forces consumers to either not attend an event or purchase tickets for the event at inflated prices in secondary markets; the original ticket vendors lose control over the pricing of event tickets in the secondary markets and are denied participation in any profits created by secondary markets; consumers are subject to the purchase of fraudulent tickets; and event organizers are forced to deal with denying admission to an event to unhappy consumers who have purchased fraudulent tickets. Further, in many jurisdictions ticket scalping is prohibited by law, however, lawmakers lack the ability to effectively enforce these laws and police the practice of ticket scalping.

### BRIEF SUMMARY OF THE INVENTION

It is an objective of the present invention to overcome at least some of the deficiencies or problems in prior art approaches to reducing the unauthorized resale of event tickets.

According to an aspect of the invention there is provided a method for reducing the unauthorized resale of tickets to an event comprising:
(a) reading valued identification information (“read valued identification information”) from one or more valued identifications at one or more locations at the event away from the entrance of the event and communicating the read valued identification information to a server;
(b) reading ticket information from a ticket at the entrance of the event and communicating the ticket information to the server;
(c) determining by the server whether to grant access to the event to a ticketholder of the ticket by determining if:
   (i) the ticket information is valid; and
   (ii) the read valued identification information comprises valued identification information registered with the server in association with the ticket information (the “registered valued identification”);
(d) communicating by the server to the entrance of the event whether to grant access to the event to the ticketholder.

Determining if the ticket information is valid may comprise verifying that the ticket information matches ticket information registered with the server for the event. Determining by the server whether to grant access to the event to a ticketholder of the ticket may further comprise determining whether a predetermined period of time has not expired since the registered valued identification information was first read at a location at the event away from the entrance to the event.

The method may further comprise determining by the server if the read valued identification information is valid, and determining by the server whether to grant access to the event to a ticketholder of the ticket may further comprise determining if the registered valued identification information has been validated.

The method may further comprise communicating by the server to the location at the event away from the entrance to the event where the read valued identification information was read whether the read valued identification information is valid.

Determining by the server if the read valued identification information is valid may comprise verifying that the read valued identification information matches valued identification information registered with the server in association with one or more tickets.

Determining if the read valued identification information is valid may further comprise determining whether a preauthorization requested prior to the event from a valued identification authorization system for charging a predetermined monetary amount to an account associated with the read valued identification information was granted.

Determining if the read valued identification information is valid may further comprise requesting from a valued identification authorization system preauthorization for charging a predetermined monetary amount to an account associated with the read valued identification information and verifying that the preauthorization is granted.

The registered valued identification information may further comprise valued identification from a plurality of valued identifications. The registered valued identification information may comprise primary valued identification information and secondary valued identification information, and determining by the server whether to grant access to the event to a ticketholder of the ticket may further comprise determining if the secondary valued identification has been used to grant access to more than a predetermined number of tickets.

According to another aspect of the invention, there is provided a system for reducing the unauthorized resale of tickets to an event comprising:
(a) a valued identification validation unit for placement at the event away from the entrance of the event, the valued identification validation unit configured to read valued identification information (“read valued identification information”) from a valued identification and communicate the read valued identification information to a server;
(b) a ticket validation unit for placement at the entrance of the event, the ticket validation unit configured to read ticket information from a ticket and communicate the ticket information to the server;
(c) the server configured to:
   (i) receive valued identification information from the valued identification validation unit;
   (ii) receive ticket information from the ticket validation unit;
   (iii) determine whether to grant access to the event to a ticketholder of the ticket by determining if:
      (1) the ticket information is valid; and
      (2) the read valued identification information comprises valued identification information registered with the server in association with the ticket information (the “registered valued identification”);
   (iv) communicate to the ticket validation unit whether to grant access to the event to the ticketholder.

Determining if the ticket information is valid may comprise verifying that the ticket information matches ticket information registered with the server for the event.

Determining whether to grant access to the event to a ticketholder of the ticket may further comprise determining whether a predetermined period of time has not expired since the registered valued identification information was first read at a location at the event away from the entrance to the event.

The server may be further configured to determine if the read valued identification information is valid, and determining whether to grant access to the event to a ticketholder of the ticket may further comprise determining if the registered valued identification information has been validated.

The server may be further configured to communicate to the valued identification validation unit where the read valued identification information was read, and the valued identification validation unit is further configured to display, whether the read valued identification information is valid.

Determining if the read valued identification information is valid may comprise verifying that the read valued identification information matches valued identification information registered with the server in association with one or more tickets.

Determining if the read valued identification information is valid may further comprise determining whether a preauthorization requested prior to the event from a valued identification authorization system for charging a predetermined monetary amount to an account associated with the read valued identification information was granted.

Determining if the read valued identification information is valid may further comprise requesting from a valued identification authorization system preauthorization for charging a predetermined monetary amount to an account associated with the read valued identification information and verifying that the preauthorization is granted.

The registered valued identification information may comprise valued identification from a plurality of valued identifications. The registered valued identification information may comprise primary valued identification information and secondary valued identification information, and determining by the server whether to grant access to the event to a ticketholder of the ticket may further comprise determining if the secondary valued identification has been used to grant access to more than a predetermined number of tickets.

According to another aspect of the invention, there is provided a method for reducing the unauthorized resale of tickets to an event comprising:
(a) receiving by a server mobile device identification (“received mobile device information”) information communicated from one or more mobile devices;
(b) reading ticket information from a ticket at the entrance of the event and communicating the ticket information to the server;
(c) determining by the server whether to grant access to the event to a ticketholder of the ticket by determining if:
   (i) the ticket information is valid; and
   (ii) the received mobile device information comprises mobile device identification information registered with the server in association with the ticket information (the “registered mobile device identification information”)
(d) communicating by the server to the entrance of the event whether to grant access to the event to the ticketholder.

Determining if the ticket information is valid may comprise verifying that the ticket information matches ticket information registered with the server for the event.

Determining by the server whether to grant access to the event to a ticketholder of the ticket may further comprise determining whether a predetermined period of time has not expired since the registered mobile device identification information was first communicated to the server by the mobile device associated with the mobile device identification information.

The method may further comprise determining by the server if the received mobile device identification information is valid.

The method may further comprise communicating by the server to each mobile device whether the received mobile device identification information from the mobile device is valid.

Determining by the server if the received mobile device identification information is valid may comprise verifying that the received mobile device information matches mobile device identification information registered with the server in association with one or more tickets.

The method may further comprise determining by the server if valued identification information registered with the server in association with received mobile device identification information is valid, and determining by the server whether to grant access to the event to a ticketholder of the ticket may further comprise determining if the valued identification information registered in association with the registered mobile device identification information has been validated.

The method may further comprise communicating by the server to each mobile device whether the valued identification registered with the server in association with the received mobile device identification information from the mobile device is valid.

Determining by the server if the valued identification information registered with the server in association with received mobile device identification information is valid may further comprise determining whether a preauthorization requested prior to the event from a valued identification authorization system for charging a predetermined monetary amount to an account associated with valued identification information was granted.

Determining by the server if the valued identification information registered with the server in association with received mobile device identification information is valid may further comprise requesting from a valued identification authorization system preauthorization for charging a predetermined monetary amount to an account associated with valued identification information and verifying that the preauthorization is granted.

The method may further comprise receiving by the server valued identification information (“received valued identification information”) from the one or more mobile devices in association with the received mobile device identification information and determining by the server whether the received valued identification information is valid, and determining by the server whether to grant access to the event to a ticketholder of the ticket may further comprise determining if valued identification information registered with the server in association with the registered mobile device identification information has been validated.

The method may further comprise communicating by the server to each mobile device whether the received valued identification is valid.

Determining by the server if the received valued identification information is valid may further comprise determining whether a preauthorization requested prior to the event from a valued identification authorization system for charging a predetermined monetary amount to an account associated with received valued identification information was granted.

Determining by the server if the received valued identification information is valid may further comprise requesting from a valued identification authorization system preauthorization for charging a predetermined monetary amount to an account associated with the received valued identification information and verifying that the preauthorization is granted.

The method may further comprise receiving by the server positioning information (“received positioning information”) from the one or more mobile devices and determining by the server if the received positioning information is valid, and determining by the server whether to grant access to the event to a ticketholder of the ticket may further comprise determining by the server whether positioning information has been received from the mobile device associated with the registered mobile device identification information and whether the positioning information has been validated.

The method may further comprise communicating by the server to each mobile device whether the received positioning information from the mobile device is valid.

Determining by the server if the received positioning information is valid may comprise determining if the mobile device is within a predetermined minimum proximity to the event.

According to another aspect of the invention, there is provided a system for reducing the unauthorized resale of tickets to an event comprising:
(a) a ticket validation unit for placement at the entrance of the event, the ticket validation unit configured to read ticket information from a ticket and communicate the ticket information to a server;
(b) the server configured to:
   (i) receive valued identification information (“received valued identification information”) from one or more mobile devices;
   (ii) receive ticket information from the ticket validation unit;
   (iii) determine whether to grant access to the event to a ticketholder of the ticket by determining if:
      (1) the ticket information is valid; and
      (2) the read valued identification information comprises valued identification information registered with the server in association with the ticket information (the “registered valued identification”);
   (iv) communicate to the ticket validation unit whether to grant access to the event to the ticketholder.

Determining if the ticket information is valid may comprise verifying that the ticket information matches ticket information registered with the server for the event.

Determining whether to grant access to the event to a ticketholder of the ticket may further comprise determining whether a predetermined period of time has not expired since the registered mobile device identification information was first communicated to the server by the mobile device associated with the mobile device identification information.

The server may be further configured to determine if the received mobile device identification information is valid. The server may be further configured to communicate to each mobile device whether the received mobile device identification information from the mobile device is valid.

Determining if the received mobile device identification information is valid may comprise verifying that the received mobile device information matches mobile device identification information registered with the server in association with one or more tickets.

The server may be further configured to determine if valued identification information registered with the server in association with received mobile device identification information is valid, and determining whether to grant access to the event to a ticketholder of the ticket may further comprise determining if the valued identification information registered in association with the registered mobile device identification information has been validated.

The server may be further configured to communicate to each mobile device whether the valued identification registered with the server in association with the received mobile device identification information from the mobile device is valid.

Determining if the valued identification information registered with the server in association with received mobile device identification information is valid may further comprise determining whether a preauthorization requested prior to the event from a valued identification authorization system for charging a predetermined monetary amount to an account associated with valued identification information was granted.

Determining if the valued identification information registered with the server in association with received mobile device identification information is valid may further comprise requesting from a valued identification authorization system preauthorization for charging a predetermined monetary amount to an account associated with valued identification information and verifying that the preauthorization is granted.

The server may be further configured to receive valued identification information (“received valued identification information”) from the one or more mobile devices in association with the received mobile device identification information and determine whether the received valued identification information is valid, and determining whether to grant access to the event to a ticketholder of the ticket may further comprise determining if valued identification information registered with the server in association with the registered mobile device identification information has been validated.

The system may further comprise communicating by the server to each mobile device whether the received valued identification is valid.

Determining if the received valued identification information is valid may further comprise determining whether a preauthorization requested prior to the event from a valued identification authorization system for charging a predetermined monetary amount to an account associated with received valued identification information was granted.

Determining if the received valued identification information is valid further comprises requesting from a valued identification authorization system preauthorization for charging a predetermined monetary amount to an account associated with the received valued identification information and verifying that the preauthorization is granted.

The server may be further configured to receive positioning information (“received positioning information”) from the one or more mobile devices and determine if the received positioning information is valid, and determining whether to grant access to the event to a ticketholder of the ticket may further comprise determining whether positioning information has been received from the mobile device associated with the registered mobile device identification information and whether the positioning information has been validated.

The server may be further configured to communicate to each mobile device whether the received positioning information from the mobile device is valid.

Determining if the received positioning information is valid may comprise determining if the mobile device is within a predetermined minimum proximity to the event.

According to another aspect of the invention, there is provided a method for reducing the unauthorized resale of tickets to an event, the method comprising:
(a) receiving at a server a request from a purchaser to purchase a ticket to the event;
(b) requesting by the server from the purchaser valued identification information of the purchaser;
(c) receiving at the server the valued identification information.
(d) registering by the server the valued identification information in association with the ticket;
(e) after registration of the valued identification information and prior to the event:
   (i) requesting by the server from a valued identification authorization system preauthorization for charging a predetermined monetary amount to an account associated with the valued identification information registered in association with the ticket; and
   (ii) registering by the server the valued identification information as invalid if the preauthorization is not granted.

The preauthorization may be requested within one week from of the event, within 24 hours from the event, and/or on the day of the event.

The method may further comprise receiving at the server a request from the purchaser to update the valued identification information of the purchaser registered in association with the ticket, and registering by the server the update to the valued identification information in association with the ticket.

The method may further comprise receiving at the server from the purchaser a request for the seat view from a seat at the event, and communicating by the server to the purchaser the seat view from the seat.

According to another aspect of the invention, there is provided a method for reducing the unauthorized resale of tickets to an event, the method comprising:
(a) receiving at a server a request from a purchaser of a ticket to the event to allocate the ticket to a ticketholder;
(b) requesting by the server valued identification information of the ticketholder;
(c) receiving at the server the valued identification information of the ticketholder;
(d) requesting by the server from a valued identification authorization system a first preauthorization for charging a predetermined monetary amount to an account associated with the valued identification information; and
(e) registering by the server the valued identification information in association with the ticket if the first preauthorization is granted by the valued identification authorization system.

Valued identification information of the ticketholder may be requested to and received from the purchaser. Valued identification information of the ticketholder may be requested to and received from the ticketholder.

The method may further comprise receiving at the server a request from the purchaser to update the valued identification information of the ticketholder registered in association with the ticket, and registering by the server the update to the valued identification information in association with the ticket.

The method may further comprise receiving at the server a request from the ticketholder to update the valued identification information of the ticketholder registered in association with the ticket, and registering by the server the update to the valued identification information in association with the ticket.

The method may further comprise, after registration of the valued identification information and prior to the event:
(a) requesting by the server from a valued identification authorization system a second preauthorization for charging a predetermined monetary amount to an account associated with the valued identification information registered in association with the ticket; and
(b) registering by the server the valued identification information as invalid if the preauthorization is not granted.

The second preauthorization may be requested within one week from of the event, within 24 hours from the event, and/or on the day of the event.

According to another aspect of the invention, there is provided a method for reducing the unauthorized resale of tickets to an event, the method comprising:
(a) receiving at a server from a plurality of purchasers a plurality of bids to purchase one or more tickets to the event, each bid comprising a desired type ticket type;
(b) communicating by the server the plurality of bids to a plurality of sellers;
(c) receiving at the server from a seller an offer to sell one or more previously purchased tickets to the event to one or more of the plurality of purchasers (“offered purchasers”);
(d) communicating by the server the offer to the offered purchasers; and
(e) upon the first receipt by the server of an acceptance of the offer from an offered purchaser, registering by the server valued identification information of the offered purchaser in association with ticket information of the one or more previously purchased tickets.

At least one of the bids may comprise a desired ticket type comprising a desired price category, a desired price range, a desired area at the event, and/or desired seat locations at the event.

At least one of the bids may comprise a time limit for which the bid is valid.

The offer may comprise a price and/or the number of previously purchased tickets that must be purchased together.

The method may further comprise communicating by the server the plurality of bids to a plurality of sellers comprises posting the plurality of bids to a website accessible by the plurality of sellers.

The method may further comprise, upon the first receipt by the server of an acceptance of the offer from an offered purchaser, communicating by the server to each of the other offered purchasers that the offer has been accepted.

The method may further comprise receiving at the server from an offered purchaser a request for the seat view from a seat at the event associated with a previously purchased ticket offered under the offer, and communicating by the server to the offered purchaser the seat view from the seat.

The method may further comprise receiving at the server from a purchaser a request for historical information respecting the resale of previously purchased tickets to the event, and communicating by the server to the purchaser the historical information. The historical information may comprise information respecting one or more of: previous bids for tickets to the event; offers to previous bids; and completed resales of previously purchased tickets to the event.

### BRIEF DESCRIPTION OF THE DRAWINGS

FIG. 1 is a system diagram of a ticket management system according to one embodiment of the present invention;

FIG. 2 is a process diagram of a method of purchasing an event ticket employed by the ticket management system shown in FIG. 1.

FIG. 3 is a process diagram of a method of modifying the registered ticketholder associated with an event ticket employed by the ticket management system shown in FIG. 1.

FIG. 4 is a process diagram of a method of modifying the registered ticketholder valued identification associated with an event ticket employed by the ticket management system shown in FIG. 1.

FIG. 5 is a system diagram of a ticket authentication system according to one embodiment of the present invention;

FIG. 6 is a process diagram of method of authenticating a ticket at an event employed by the ticket authentication system shown in FIG. 5.

FIG. 7 is a system diagram of a secondary market system according to one embodiment of the present invention.

FIG. 8a is a process diagram of a method of posting one or more previously purchased tickets for sale employed by the secondary market system shown in FIG. 7.

FIG. 8b is a process diagram of method of purchasing one or more previously purchased tickets that have been posted for sale employed by the secondary market system shown in FIG. 7.

FIG. 9a is a process diagram of a method of bidding for the purchase of a previously purchased ticket employed by the secondary market system shown in FIG. 7.

FIG. 9b is a process diagram of a method of offering a previously purchased ticket to fulfill a bid for the purchase of a ticket employed by the secondary market system shown in FIG. 7.

FIG. 10 is a system diagram of a mobile device for use as a valued identification validation unit according to one embodiment of the present invention.

FIG. 11 is a process diagram of a method of offering for resale tickets to event segments of a segmented event.

### DETAILED DESCRIPTION OF EMBODIMENTS OF THE INVENTION

The embodiments of the present invention relate to systems and methods for reducing ticket scalping. Particularly, the embodiments relate to: (a) a primary market ticket management system for purchasing and allocating event tickets; (b) a ticket authentication system for authenticating tickets presented at an event; and (c) a secondary market system for the authorized resale of event tickets. These systems, individually and collectively, facilitate the reduction of ticket scalping by requiring the production of valid registered valued identification for the purchase, allocation, and resale of event tickets and the admittance to an event.

Throughout the detailed description the term “valued identification” is used to refer to identification that is registered in the name of the owner of the identification and can be charged a value for the purchase of goods and/or services, including without limitation, credit cards, debit credit cards, prepaid credit cards, closed-loop or semi-closed loop credit cards that can only be used with specific merchants, and charge cards. Valued identification may be in the form of a card or other media that contains valued identification information, such as for example: magnetic strips; integrated circuits; computer readable mediums; contactless media using near field communications technologies, such as, for example, radio frequency identification tags, PayPass™, contactless payment stickers, mobile communication devices; or other storage media known to one skilled in the art. The valued identification information may include account number information, owner information, expiration date information, service code information, verification information (i.e. PIN or card verification information, such as, for example, card verification code (CVC), card verification valued code (CVVC), card verification value (CVV), card security code (CSC), card verification data (CVD), verification code (V Code) or card code verification (CCV)), and other similar information known to one skilled in the art.

In addition, throughout the disclosure where a server or computer is referenced it may include one or more servers or computers located at one or more locations communicating through one or more networks. Where a processor is referenced it may include one or more processors located at one more locations communicating through one or more networks, including without limitation, application specific circuits, programmable logic controllers, field programmable gate arrays, microcontrollers, microprocessors, virtual machines, electronic circuits and other processing devices known to one skilled in the art. Where a computer readable medium is referenced it may include one or more computer readable mediums located at one more locations communicating through one or more networks, including without limitation, random access memory, flash memory, read only memory, hard disc drives, optical drives and optical drive media, flash drives, and other computer readable storage media known to one skilled in the art. Where a network is referenced it may include one or more networks, including without limitation, local area networks, wide area networks, intranets, the Internet, and other networks known to one skilled in the art. Where a communication, transmission or informing of information is referenced it may be communicated over any electronic communication medium and in any format known to one skilled in the art, including without limitation, wired or wireless mediums, compressed or uncompressed formats, encrypted or unencrypted formats, email, facsimile, Short Message Service or text messages, Multimedia Messaging Service or multimedia messages, instant messaging, and website posts.

Primary Market Ticket Management System

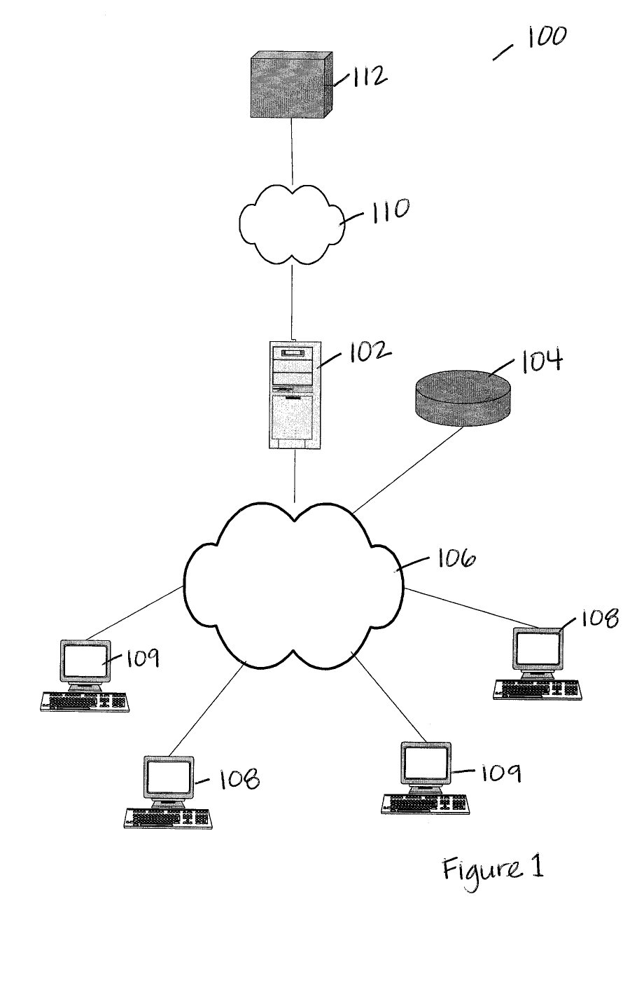

Referring to FIG. 1 a primary market ticket management system 100 is shown. The system 100 enables users to purchase tickets to an event that are made available by original tickets vendors and allocate purchased tickets to specified ticketholders. The system 100 comprises a ticket server 102, a data server 104, a network 106, user terminals 108, ticket vendors 109, a network 110, and a valued identification authorization system 112.

The ticket server 102 comprises a processor and a computer readable medium (not shown). The computer readable medium contains instructions stored therein that when executed by the processor perform the ticket management method as further described below. The ticket server 102 communicates with the data server 104, user terminals 108, and ticket vendors 109 through network 106, and the valued identification authorization system 112 through network 110.

The data server 104 comprises a processor and a computer readable medium (not shown). The computer readable medium contains instructions stored therein that when executed by the processor facilitate the management, communication, access and storage of data on the data server 104. The data may comprise information respecting the identification, validity, availability, purchase, ownership and allocation of event tickets. In one embodiment, the data consists of account information (i.e. user name, password, contact information, mobile device identification information, etc.), the status of each ticket (i.e. purchased, available for purchase, etc.), ticket information (i.e. ticket identification information, event information, seat information, price, price category, etc.), ownership information (i.e. the original purchaser of each ticket, the ticketholder of each ticket, contact information of the original purchaser, contact information of the ticketholder, mobile device identification information, etc.), purchase restrictions (i.e. maximum number of tickets that can be purchased by each purchaser, prohibited purchasers, permitted purchasers, etc.), and valued identification information of the ticketholder of each ticket. The data server 104 communicates with the ticket server 102 through network 106. In the alternative, the data server 104 may communicate with the ticket server 102 over a separate network from network 106. In the further alternative, the data server 104 may form part of the ticket server 102.

Users can access the ticket server 102 through network 106 via a registration device, such as, user terminals 108 and ticket vendors 109. User terminals 108 may be a computer, cellular phone, personal digital assistant, gaming device or other communication device capable of communicating with a server through a network as known to one skilled in the art. The ticket vendors 109 may be a person or an automated telephone system and users may communicate with the ticket vendors 109 over the phone or in person at designated locations. In one embodiment, the ticket server 102 hosts a website and users and ticket vendors communicate with the ticket server 102 through the website via a web browser running on the user terminals 108 and ticket vendors 109.

The valued identification authorization system 112 contains information pertaining to valued identification and enables the authorization, preauthorization and charging of monetary amounts to an account associated with the valued identification. The valued identification authorization system 112 communicates with the ticket server 102 through network 110.

Primary Market Ticket Management Method

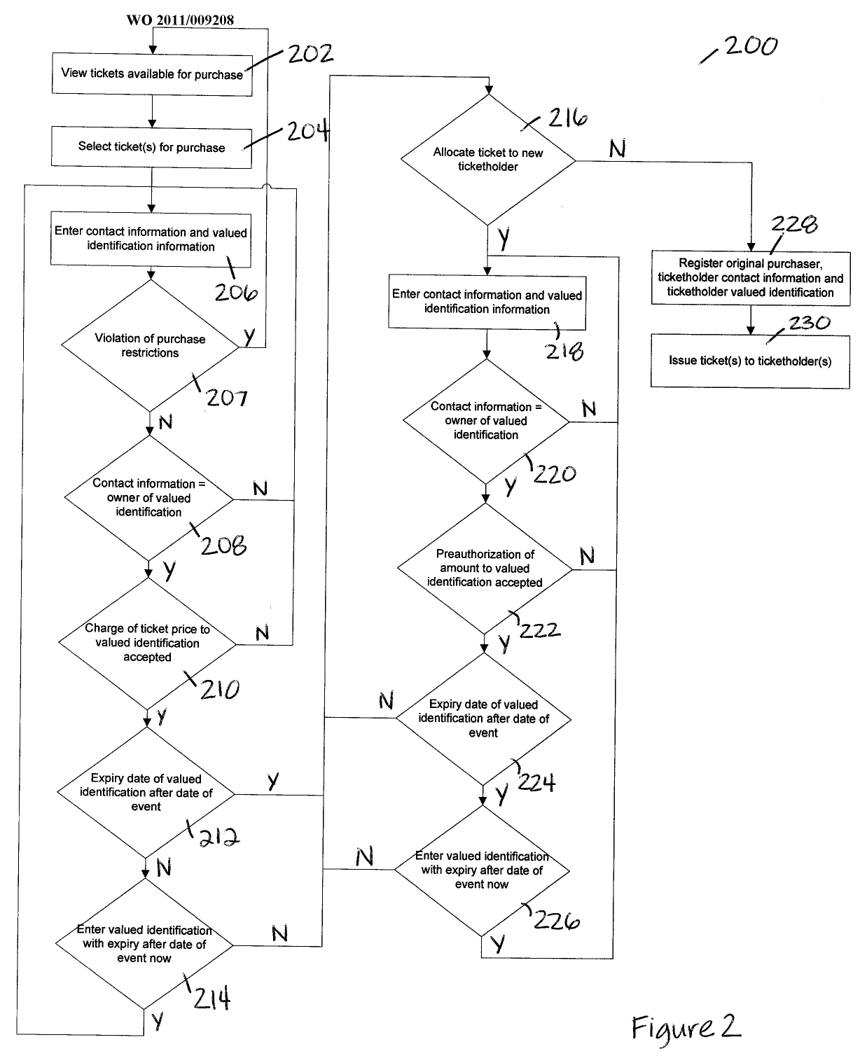

Referring to FIG. 2, a method 200 of purchasing an event ticket using system 100 is shown. In step 202, a purchaser communicates with the ticket server 102 through a user terminal 108 or ticket vendor 109 requesting a listing of tickets that are available for purchase for a particular event. The ticket server 102 queries the data server 104 to acquire the listing and communicates the listing to the user terminal 108 or ticket vendor 109. In step 204, the purchaser selects one or more tickets for purchase. The ticket server 102 then holds the selected tickets for a predetermined period during which other purchasers are prohibited from selecting the held tickets for purchase.

In step 206, the ticket server 102 prompts the purchaser to enter the purchaser's account information previously registered with the ticket server 102 or create a new account with the ticket server 102. If the purchaser elects to create a new account, the ticket server 102 prompts the purchaser to enter desired account information, the purchaser's contact information and the purchaser's valued identification information. The ticket server 102 then communicates with the data server 104 to register the new account information in association with the purchaser. If the purchaser enters previously registered account information, the ticket server 102 queries the data server 104 to authenticate the account information. If the account information is invalid, the ticket server 102 prompts the purchaser for valid account information or the creation of a new account, otherwise, the ticket server 102 queries the data server 104 for the purchaser's contact information and valued identification information registered with the purchaser's account and provides this information to the purchaser. The ticket server 102 then prompts the purchaser to proceed with the registered contact information and valued identification information or enter new contact information and/or valued identification information. If the purchaser enters new contact information and/or valued identification information, the ticket server 102 communicates and registers this information with the data server 104.

The account information may comprise a user name, password, valued identification information, contact information, mobile device identification information, or other authentication information known to one skilled in the art. In one embodiment the account information consists of a user name and password. The purchaser's contact information may comprise name, home address, home phone number, cellular phone number, email address, and other forms of contact information known to one skilled in the art. In one embodiment, the purchaser's contact information consists of the purchaser's name, address, and email address. The purchaser's valued identification information may comprise account number information, owner information, expiration date information, service code information, verification information (i.e. PIN or card verification information, such as, for example, card verification code (CVC), card verification valued code (CVVC), card verification value (CVV), card security code (CSC), card verification data (CVD), verification code (V Code) or card code verification (CCV)), and other similar information known to one skilled in the art. In one embodiment, the purchaser's valued identification information consists of account number information, owner information, and expiration date information.

In step 207, the ticket server 102 queries the data server 104 to determine if any purchase restrictions have been violated by the purchaser. Purchase restrictions may comprise maximum number of tickets that can be purchased by each purchaser, prohibited purchasers, permitted purchasers, and other restrictions known to one skilled in the art. In one embodiment the purchase restrictions consist of the maximum number of tickets that can be purchased by each purchaser. If the purchaser has violated a purchase restriction, the ticket server 102 proceeds to step 202, otherwise, the ticket server 102 proceeds to step 208. In step 208, the ticket server 102 compares the purchaser's contact information to the ownership information of the purchaser's valued identification. If the purchaser's contact information does not match the ownership information of the purchaser's valued identification the ticket server 102 informs the purchaser and proceeds to step 206, otherwise, the ticket server 102 proceeds to step 210. In step 210, the ticket server 102 communicates the purchaser's valued identification information to the valued identification authorization system 112 through network 110 along with a request to charge the price of the tickets to the account associated with the purchaser's valued identification. If the charge request is denied by the valued identification authorization system 112, the ticket server 102 informs the purchaser and proceeds to step 206, otherwise, the ticket server 102 proceeds to step 212.

In step 212, the ticket server 102 compares the expiry date of the purchaser's valued identification to the date of the event. If the expiry date of the purchaser's valued identification is after the date of the event, the ticket server 102 proceeds to step 216, otherwise, the ticket server 102 proceeds to step 214. In step 214, the ticket server 102 informs the purchaser that prior to the date of the event the purchaser must register valued identification with the ticket server 102 having an expiry date after the date of the event. The purchaser is prompted to either enter new valued identification having an expiry date after the date of the event or indicate that the purchaser will enter such valued identification at a later time prior to the date of the event (i.e. by selection of a check box or other manner of indication known to one skilled in the art). If the purchaser selects the entry of new valued identification, the ticket server 102 proceeds to step 206, otherwise, the ticket server 102 proceeds to step 216.

In step 216, the ticket server 102 prompts the purchaser to select one or more of the purchased tickets for which the purchaser desires to allocate to a new ticketholder other than the purchaser. If the purchaser desires to allocate any of the purchase tickets to a new ticketholder, the ticket server 102 proceeds to step 218, otherwise the ticket server 102 proceeds to step 228. In step 218, the ticket server 102 prompts the purchaser to select a ticket and enter the contact information and valued identification information of the new ticketholder. The ticketholder's contact information may comprise name, home address, home phone number, cellular phone number, email address, and other forms of contact information known to one skilled in the art. In one embodiment, the ticketholder's contact information consists of the ticketholder's name, address, and email address. The ticketholder's valued identification information may comprise account number information, owner information, expiration date information, service code information, verification information (i.e. PIN or card verification information, such as, for example, card verification code (CVC), card verification valued code (CVVC), card verification value (CVV), card security code (CSC), card verification data (CVD), verification code (V Code) or card code verification (CCV)), and other similar information known to one skilled in the art. In one embodiment, the ticketholder's valued identification information consists of account number information, owner information, and expiration date information.

In step 220, the ticket server 102 compares the new ticketholder's contact information to the ownership information of the new ticketholder's valued identification. If the ticketholder's contact information does not match the ownership information of the ticketholder's valued identification the ticket server 102 informs the purchaser and proceeds to step 218, otherwise, the ticket server 102 proceeds to step 222. In step 222, the ticket server 102 communicates the ticketholder's valued identification information to the valued identification authorization system 112 through network 110 along with a request for a preauthorization of a predetermined amount. In one embodiment, the predetermined amount is the price of the ticket. If the preauthorization request is denied by the valued identification authorization system 112, the ticket server 102 informs the purchaser and proceeds to step 218, otherwise, the ticket server 102 proceeds to step 224.

In step 224, the ticket server 102 compares the expiry date of the new ticketholder's valued identification to the date of the event. If the expiry date of the new ticketholder's valued identification is after the date of the event, the ticket server 102 proceeds to step 216, otherwise, the ticket server 102 proceeds to step 226. In step 226, the ticket server 102 informs the purchaser that prior to the date of the event the purchaser or ticketholder must register valid ticketholder valued identification information with the ticket server 102 having an expiry date after the date of the event. The purchaser is prompted to either enter new ticketholder valued identification information having an expiry date after the date of the event or indicate that the purchaser and/or ticketholder will enter new ticketholder valued identification at a later time prior to the date of the event (i.e. by selection of a check box or other manner of indication known to one skilled in the art). If the purchaser selects the entry of new ticketholder valued identification information, the ticket server 102 proceeds to step 218, otherwise, the ticket server 102 proceeds to step 216.

In step 228, the ticket server 102 instructs the data server 104 to update the information associated with the purchased tickets. Specifically, for each purchased ticket the ticket server 102: (a) sets the status of the ticket as “purchased”; (b) registers the purchaser as the original purchaser of the ticket; (c) registers the purchaser's contact information and valued identification information; and (d) registers the ticketholder's contact information and valued identification information.

In step 230, the ticket server 102 issues the purchased tickets to the registered ticketholder of each ticket. In one embodiment the ticket is an electronic ticket that is delivered to the registered ticketholder via email, text message, the website hosted by the ticket server 102, or other electronic communication method known to one skilled in the art. In an alternative embodiment, the ticket may be a physical ticket that is sent to the registered ticketholder via mail or courier, or picked up by the ticketholder at a specified location.

In a further alternative embodiment, electronic tickets allocated to ticketholder's other than the registered original purchaser may be encrypted such that the ticket cannot be easily transferred to a third party. For example, in step 230, the ticket server 102 issues an email message to the registered ticketholder of each ticket. The message instructs the ticketholder to access the web page hosted by the ticket server 102. When the ticketholder accesses the web page, the ticket server 102 prompts the ticketholder for the ticketholder's registered contact information and valued identification information. In one embodiment, the ticketholder is prompted for the ticketholder's email address and the last 5 digits of the account number of the ticketholder's valued identification information. The ticket server 102 then queries the data server 104 to validate the contact information and valued identification information entered by the ticketholder. If the information is valid, the ticket server 102 displays an electronic ticket on the webpage in a form that can only be printed and not saved or forwarded, in a manner is known to one skilled in the art. The ticketholder can print a copy of the ticket to take to the event, but cannot easily electronically transfer the ticket to a third party. Optionally, the ticket server 102 may store the Internet Protocol address of the user terminal 108 that the ticketholder is using to access the ticket server 102. If the ticketholder or a third party subsequently attempts to access the ticket server 102 from user terminal 108 having a different Internet Protocol address than the user terminal 108 first used to access the ticket serve 102, the ticket server 102 may deny the user access to the electronic ticket or prompt the user for additional validation information.

At any time up to an including the date of the event, the registered original purchaser of a ticket may access the ticket server 102 to reissue the ticket, reallocate the ticket, change the registered ticketholder contact information, or change the registered ticketholder valued identification. In addition, at any time up to an including the date of the event, the registered ticketholder may access the ticket server 102 to change the registered ticketholder valued identification if the registered ticketholder valued identification will expire prior to the date of the event.

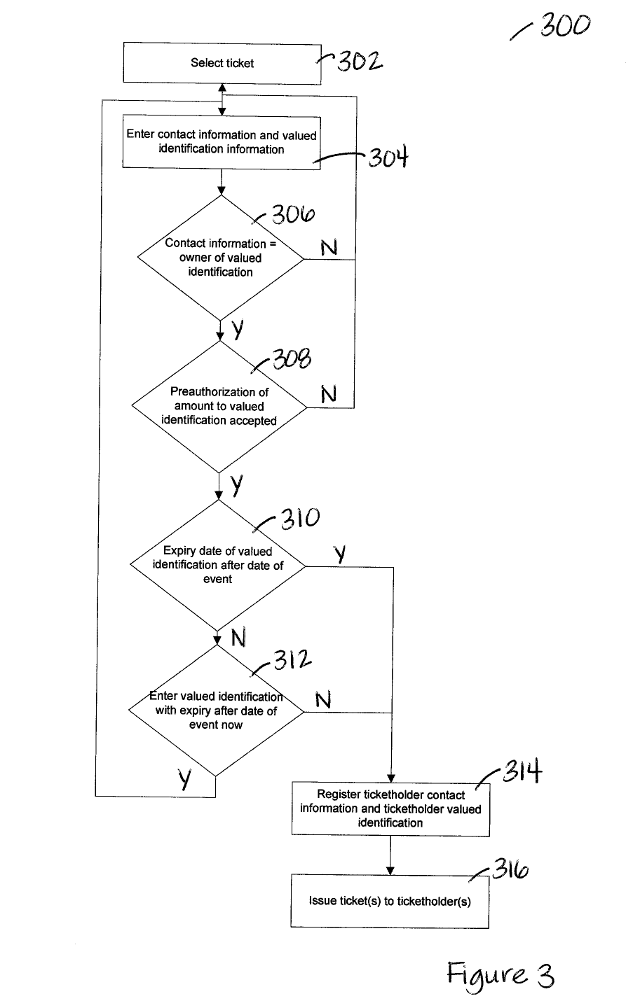

Referring to FIG. 3, a method 300 of reallocating a ticket using system 100 is shown. In step 302, the registered original purchaser selects a ticket to which the purchaser desires to change the registered ticketholder contact information. In step 304, the ticket server 102 prompts the registered original purchaser to enter the new ticketholder's contact information and valued identification information, in the same form as described above in step 218 of method 200. In step 306, the ticket server 102 compares the new ticketholder's contact information to the ownership information of the new ticketholder's valued identification. If the ticketholder's contact information does not match the ownership information of the ticketholder's valued identification the ticket server 102 informs the purchaser and proceeds to step 304, otherwise, the ticket server 102 proceeds to step 308. In step 308, the ticket server 102 communicates the ticketholder's valued identification information to the valued identification authorization system 112 through network 110 along with a request for a preauthorization of a predetermined amount. In one embodiment, the predetermined amount is the price of the ticket. If the preauthorization request is denied by the valued identification authorization system 112, the ticket server 102 informs the registered original purchaser and proceeds to step 304, otherwise, the ticket server 102 proceeds to step 310.

In step 310, the ticket server 102 compares the expiry date of the new ticketholder's valued identification to the date of the event. If the expiry date of the new ticketholder's valued identification is after the date of the event, the ticket server 102 proceeds to step 314, otherwise, the ticket server 102 proceeds to step 312. In step 312, the ticket server 102 informs the registered original purchaser that prior to the date of the event the registered original purchaser or ticketholder must register valid ticketholder valued identification information with the ticket server 102 having an expiry date after the date of the event. The registered original purchaser is prompted to either enter new ticketholder valued identification information having an expiry date after the date of the event or indicate that the purchaser and/or ticketholder will enter new ticketholder valued identification at a later time prior to the date of the event (i.e. by selection of a check box or other manner of indication known to one skilled in the art). If the purchaser selects the entry of new ticketholder valued identification information, the ticket server 102 proceeds to step 304, otherwise, the ticket server 102 proceeds to step 314.

In step 314, the ticket server 102 instructs the data server 104 to register the new ticketholder's contact information and valued identification information in association with the ticket. In step 316, the ticket server 102 reissues the ticket to the new ticketholder. In one embodiment the ticket is an electronic ticket that is delivered to the registered ticketholder via email, text message, the website hosted by the ticket server 102, or other electronic communication method known to one skilled in the art. Optionally, electronic tickets may be encrypted, as described above in relation to method 200, such that the ticket cannot be transferred to a third party. In the alternative, the ticket may be a physical ticket that is sent to the registered ticketholder via mail or courier, or picked up by the ticketholder at a specified location.

In a further alternative embodiment, in step 230 of method 200 and step 316 of method 300, the registered original purchaser is prompted to select one of the following methods of delivery for the purchased tickets: 1) delivery of the physical tickets by courier or mail; 2) pickup of physical tickets at location, for example, at a will call window; or 3) electronic delivery of electronic tickets. Optionally, the purchaser may select a different method of delivery for each ticket. Where electronic delivery is selected, the ticket server 102 will delay electronic delivery of the electronic tickets to the registered ticketholders until a predetermined period before the start of the event, such as, for example, 24 hours prior to the start of the event. In the alternative, the predetermined period may be configured to be any period prior to the start of the event. In the further alternative, the electronic delivery of electronic tickets may be delayed until the valued identification associated with each ticket is subsequently verified at a predetermined minimum period prior to the start of the event as further described below. Amongst other benefits, the delayed delivery of electronic tickets to the predetermined period places an additional impediment to ticketholders attempting to resell their electronic tickets using unauthorized channels.

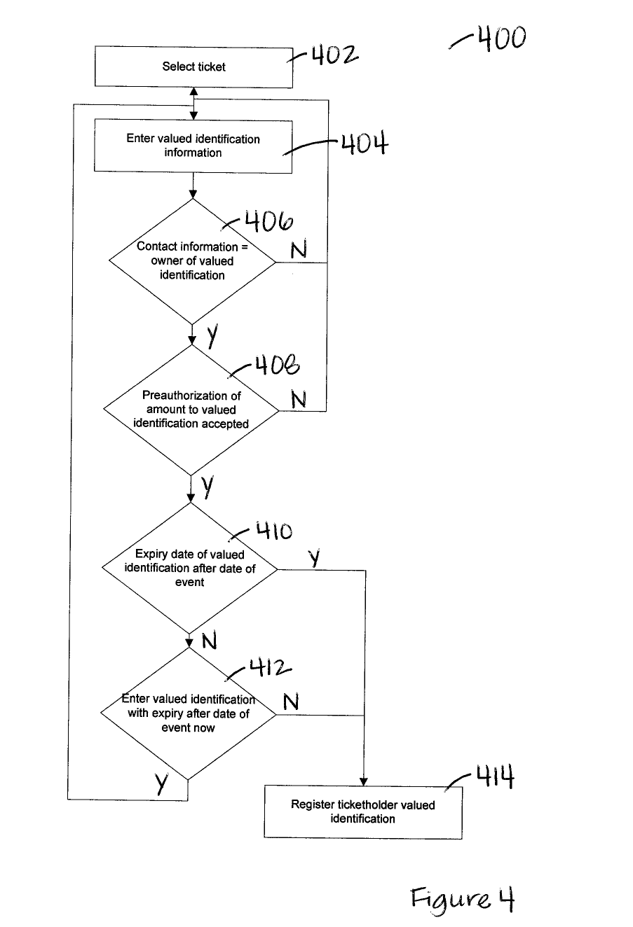

Referring to FIG. 4, a method 400 of changing the registered ticketholder valued identification information using system 100 is shown. In step 402, the registered original purchaser or registered ticketholder selects a ticket for which the registered ticketholder valued identification information is desired to be changed. In step 404, the ticket server 102 prompts the registered original purchaser or registered ticketholder to enter the new ticketholder valued identification information, in the same form as described above in step 218 of method 200. In step 406, the ticket server 102 compares the registered ticketholder contact information to the ownership information of the new ticketholder valued identification. If the registered ticketholder contact information does not match the ownership information of the new ticketholder valued identification the ticket server 102 informs the registered original purchaser or registered ticketholder and proceeds to step 404, otherwise, the ticket server 102 proceeds to step 408. In step 408, the ticket server 102 communicates the new ticketholder valued identification information to the valued identification authorization system 112 through network 110 along with a request for a preauthorization of a predetermined amount. In one embodiment, the predetermined amount is the price of the ticket. If the preauthorization request is denied by the valued identification authorization system 112, the ticket server 102 informs the registered original purchaser or registered ticketholder and proceeds to step 404, otherwise, the ticket server 102 proceeds to step 310.

In step 410, the ticket server 102 compares the expiry date of the new ticketholder valued identification to the date of the event. If the expiry date of the new ticketholder valued identification is after the date of the event, the ticket server 102 proceeds to step 414, otherwise, the ticket server 102 proceeds to step 412. In step 412, the ticket server 102 informs the registered original purchaser or registered ticketholder that prior to the date of the event the registered original purchaser or ticketholder must register valid ticketholder valued identification information with the ticket server 102 having an expiry date after the date of the event. The registered original purchaser or registered ticketholder is prompted to either enter new ticketholder valued identification information having an expiry date after the date of the event or indicate that the registered original purchaser or registered ticketholder will enter new ticketholder valued identification at a later time prior to the date of the event (i.e. by selection of a check box or other manner of indication known to one skilled in the art). If the registered original purchaser or registered ticketholder selects the entry of new ticketholder valued identification information, the ticket server 102 proceeds to step 404, otherwise, the ticket server 102 proceeds to step 414. In step 414, the ticket server 102 instructs the data server 104 to register the new ticketholder valued identification information in association with the ticket.

The ticket server 102 may perform one or more verifications of the registered ticketholder valued identification information prior to and/or including the date of the event. For each verification, the ticket server 102 communicates the registered ticketholder valued identification information to the valued identification authorization system 112 through network 110 along with a request for a preauthorization of a predetermined amount. In one embodiment the predetermined amount is the price of the ticket. If the registered ticketholder contact information does not match the owner information associated with the registered ticketholder valued identification or the preauthorization request is denied by the valued identification authorization system 112, the ticket server 102 marks the registered ticketholder valued identification information associated with the ticket as invalid. Optionally, the ticket server 102 may send one or more communications to the registered original purchaser and/or the registered ticketholder informing the recipients that the registered ticketholder valued identification information is invalid and the ticketholder will not be admitted to the event until valid ticketholder valued identification information is registered with the ticket server 102. In one embodiment, the verification of the registered ticketholder valued identification is performed by the ticket server 102 on the date of the event immediately prior to the opening of the event. In an alternative embodiment, the verification of the registered ticketholder valued identification is performed by the ticket server 102 within a twenty four hour period before the start of the event.

The ticket server 102 may perform one or more checks of the expiry date of the registered ticketholder valued identification up to and/or including the date of the event. If the expiry date of the registered ticketholder valued identification is on or before the date of the event, the ticket server 102 sends one or more communications to the registered ticketholder and/or registered original purchaser informing the recipients that prior to the date of the event the registered original purchaser and/or registered ticketholder must provide the ticket server 102 with valued identification of the registered ticketholder having an expiry date after the date of the event. The ticket server 102 may communicate the verification and/or comparison to the registered ticketholder and/or registered original purchaser via email, text message, mail, courier, telephone, the web site hosted by the ticket server 102, or other communication method known to one skilled in the art.

The ticket server 102 may also send one or more communications to the registered original purchaser and/or registered ticketholder up to an including the date of the event, reminding the registered original purchaser and/or registered ticketholder that the registered ticketholder must present the registered ticketholder valued identification at the event in order to be admitted to the event.

At the conclusion of an event, the ticket server 102 may optionally instruct the data server 104 to erase all information respecting the allocation of tickets to ticketholders by the registered original purchaser. In the alternative, this information may be archived by the data server 104 for future reference.

In an alternative embodiment, method 200 and method 300 may facilitate the electronic communication of ticketholder contact information and valued identification information from a new ticketholder in order to reallocate a ticket to the new ticketholder. In steps 218 and 304, the ticket server 102 provides the registered original purchaser with the option to: enter one or more electronic addresses for the new ticketholder, such as, for example, email address, mobile phone number, Instant Messaging address, mobile Personal Identification Number (PIN), or other electronic addresses known to one skilled in the art; or select the ticketholder from a list of pre-registered ticketholders with the ticket server 102 or data server 104. The ticket server 102 then transmits a message to the electronic address informing the new ticketholder that the registered original purchaser desires to allocate a ticket to the ticketholder.

The ticketholder may indicate their acceptance of the ticket by providing their contact information and valued identification information to the ticket server 102 by any electronic communication means known to one skilled in the art, such as, for example, through a website hosted by the ticket server 102 or another server for which a link is provided in the message, or through a software application running on the ticketholder's computing device that communicates the information to the ticket server 102. Alternatively, if the ticketholder has already registered their contact information and valued identification information with the ticket server 102 or data server 104, the ticketholder may authenticate themselves by providing their authentication information to the ticket server 102, such as, for example, user name and password, or other authentication information apparent to one skilled in the art. The ticketholder's communications with the ticket server 102 may be encrypted in order to provide additional security.

The new ticketholder's contact information and valued identification information is then validated in the manner described in steps 220 to 224 of method 200 or steps 306 to 312 of method 300. If the information fails validation, the ticket server 102 transmits a message to the ticketholder's electronic address providing the ticketholder with details of the failure and requesting the ticketholder to provide valid contact information and/or valued identification information. Once the new ticketholder's information is validated, the ticket server 102 informs the registered original purchaser that the ticketholder has accepted the ticket and requests the registered original purchaser to validate the information provided by the ticketholder and confirm the allocation of the ticket to the ticketholder. If the registered original purchaser confirms the allocation of the ticket to the ticketholder, the ticket server 102 registers the new ticketholder's information in association with the ticket and issues the ticket to the new ticketholder in the manner described in steps 228 to 230 of method 200 or steps 314 to 316 of method 300 in the embodiments described above. In the alternative, the ticket server 102 may automatically register the information associated with the ticket upon receipt of valid contact information and valued identification information from the ticketholder without requiring confirmation from the registered original purchaser.

Once the ticketholder's contact information and valued identification information is registered with the ticket server 102, the original registered purchaser may access the ticket server 102 at any time to view both the contact information and valued identification information. If the valued identification information is stored in an encrypted format, the registered original purchaser may instruct the ticket server 102 to decrypt valued identification information and present the decrypted information to the registered original purchaser. In the alternative, the original registered purchaser may be permitted to view the valued identification information of the ticketholder solely during the confirmation of the allocation of the ticket to the ticketholder such that after confirmation the original registered purchaser will no longer be able to access the ticketholder's valued identification information.

In a further alternative embodiment, the method of electronically communicating ticketholder information and valued identification information described above may be varied such that the ticketholder initiates communication with the ticket server 102. The ticketholder communicates with the ticker server 102 and identifies the registered original purchaser of a ticket for which the ticketholder desires to receive a ticket. In the same manner as described above, the ticketholder provides their contact information and valued identification information, or authenticates themselves with the ticket server 102 if they have a previously registered this information with the ticket server 102 or data server 104. The ticketholder's contact information and valued identification information is then validated as described above. Once the ticketholder's information is validated, the ticket server 102 informs the registered original purchaser that the ticketholder has provided valid contact information and valued identification to the ticket server 102. In one embodiment, the ticketholder's contact information and valued identification information is communicated to the registered original purchaser. In an alternative embodiment, only the ticketholder's contact information is communicated to the registered original purchaser. The registered original ticket purchaser may then select one or more tickets to allocate to the ticketholder. Once the registered original purchaser has made their selection, the ticket server 102 registers the ticketholder contact information and valued identification information with the ticket(s) and informs the ticketholder as to the details of the ticket(s) that have been allocated to them.

In a further alternative embodiment, the ticket server 102 may permit the registered original purchaser to register primary valued identification information and secondary valued identification information in association with a group of tickets. The registered original purchaser may specify a maximum number of the group of tickets for which the secondary valued identification information may permit access to the event. In the alternative, the maximum number of tickets permitted to be associated with the secondary valued identification information is predetermined by the ticket server 102. As further described in the ticket authentication method, when the secondary valued identification information is authenticated at the event, up to the maximum number of tickets associated with the secondary valued identification information may be permitted to enter the event. The primary valued identification may then be subsequently authenticated to permit any remaining tickets of the group of tickets (which exceed the maximum number of tickets associated with the secondary valued identification information or have not been utilized to enter the event based on the authentication of the secondary valued identification information) to enter the event.

In a further alternative embodiment, the original ticket vendor may restrict which registered original purchasers may add secondary valued identification information to a group of tickets. For example, the original ticket vendor may restrict this feature to season ticket holders to permit a first portion of the members of the season ticketholder's family or group to enter the event while the remaining members park the car (i.e. the season ticketholder's spouse and children may enter the event using the secondary valued identification while the season ticketholder subsequently uses the primary valued identification to enter the event).

In a further alternative embodiment, the ticket server 102 is configured to present purchasers with the view that the purchaser can expect to see from the seat that the purchaser is considering purchasing. The data server 104 stores a plurality of graphical images (each a “seat view”) depicting views at the event and registers the seat views with the associated ticket for the event. In step 202, the ticket server 102 queries the data server 104 to acquire a listing of tickets available for purchase. The ticket server 102 communicates the listing to the user terminal 108 or ticket vendor 109 along with a seat view, or link to a seat view, for each ticket in the list having an associated seat view stored in the data server 104. Before purchasing a ticket, the purchaser may select the seat view associated with the ticket to get a sense of the view from the seat or area for which the ticket relates. In one embodiment, the same seat view may be used for a predefined group of tickets, for example, the tickets relating to a block of seats at an event could have the same associated seat view representative of the view from the center seat of the block of seats. In the alternative, the seat view representative of the view from any location within the block of seats may be associated with all of the tickets in the block of seats. In the further alternative, a distinct seat view may be association with each ticket. In the further alternative, prior to purchasing a ticket, the purchaser may communicate the associated seat view to a third party via email, text message, the website hosted by the ticket server 102, or other electronic communication method known to one skilled in the art.

Ticket Authentication System

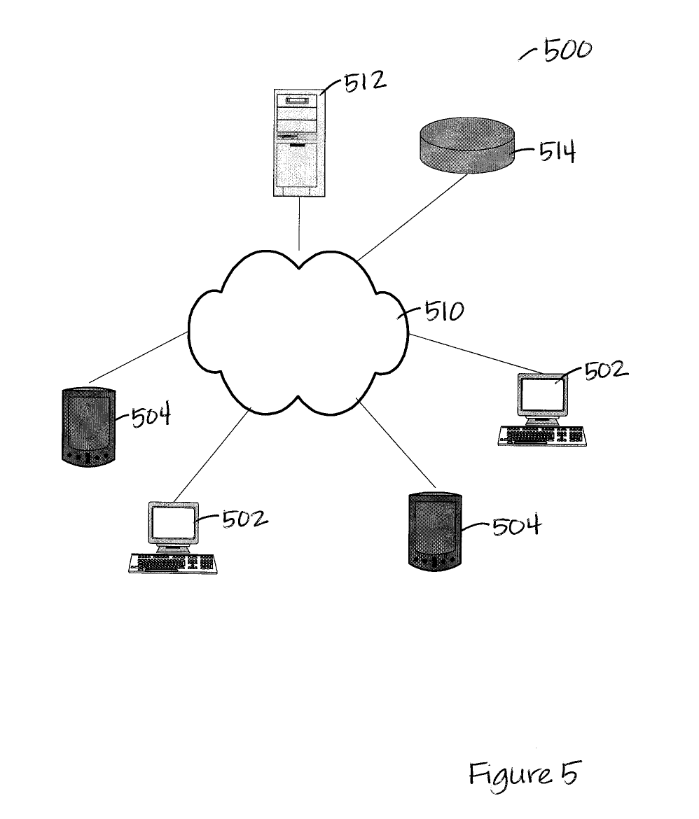

Referring to FIG. 5 a ticket authentication system 500 is shown. The system 500 authenticates event tickets presented at an event and controls access to the event by requiring event attendants to provide both an event ticket and the registered valued identification information associated with the ticket. The system 500 comprises valued identification validation units 502, ticket validation units 504, a network 510, an authentication server 512, a data server 514, and authentication assistance units (not shown).

The valued identification validation units 502 each comprise a processor, a computer readable medium, a validation indicator, and a valued identification reader (not shown). The computer readable medium contains instructions stored therein that when executed by the processor facilitates the reading of valued identification information from a piece of valued identification that is presented to the valued identification reader. The unit 502 is in communication with authentication server 512 through network 510. The unit 502 can transmit read valued identification information to the authentication server 512 and receive validation information from the authentication server 512. The validation indicator presents received validation information to the user of the unit 502. In one embodiment, the unit 502 is an automated kiosk and the validation indicator is a display. For example, the unit 502 may be a Motorola MK 2220 with a magnetic stripe reader and near field communications transceiver for reading contactless media containing valued identification information. In the alternative, the unit 502 may be any automated or non-automated device capable of providing the functionality of the unit 502 described herein. In the further alternative, the validation indicator may comprise one or more displays, speakers, lights or other devices capable of presenting visual and/or audible information. In the yet further alternative, the valued identification validation unit 502 may comprise a display and/or a printer for presenting advertisements to users of the unit 502.

The ticket validation units 504 each comprise a processor, a computer readable medium, a ticket reader, and a validation indicator (not shown). The computer readable medium contains instructions stored therein that when executed by the processor facilitates the reading of ticket information from an event ticket that is presented to the ticket reader. The unit 504 is in communication with authentication server 512 through network 510. The unit 504 can transmit read ticket information to the authentication server 512 and receive validation information from the authentication server 512. The validation indicator presents received validation information to the user of the unit 504. The validation information may comprise an indication as whether a ticket is valid, reasons why the ticket is invalid (i.e. not a valid ticket identifier, valued identification has not bee presented to a valued identification validation unit, a predetermined period of time from the first presentation of the valued identification to the valued identification unit has expired and/or the extent to which it has expired, etc), instructions on how to handle the invalid ticket and/or other information pertaining to the validity of a ticket and valued identification known to one skilled in the art.

In one embodiment, the unit 504 is handheld wireless device operated by an event associate, the validation indicator is a display integrated in the device, and the ticket reader is a barcode reader. For example, the unit 504 may be a Motorola MC55 Enterprise Digital Assistant with a bar code reader. In the alternative, the unit 504 may be any automated or non-automated device capable of providing the functionality of the unit 504 described herein. In the further alternative, the validation indicator may comprise one or more displays, speaker, lights or other devices capable of communicating visual or audible information.

The authentication server 512 comprises a processor and a computer readable medium (not shown). The computer readable medium contains instructions stored therein that when executed by the processor perform the ticket authentication method as further described below. The authentication server 512 communicates with the valued identification validation unit 502, the ticket validation unit 504 and the data server 514 through network 510.

The data server 514 comprises a processor and a computer readable medium (not shown). The computer readable medium contains instructions stored therein that when executed by the processor facilitate the management, communication, access and storage of data on the data server 514. The data may comprises information respecting the identification, validity, ownership and allocation of event tickets. In one embodiment, the data consists of the status of each ticket (i.e. not read, read, time that the ticket was read, etc.), ticket information (i.e. ticket identification information, event information, seat information, price, price category, etc.), ownership information (i.e. the original purchaser of each ticket, the ticketholder of each ticket, contact information of the original purchaser, etc.), valued identification information of the ticketholder of each ticket and the status of the valued identification (i.e. valid, invalid, not read, read, time that the valued identification was read, etc). The data server 514 communicates with the authentication server 512 through network 510. In the alternative, the data server 514 may communicate with the authentication server 512 over a separate network from network 510. In the further alternative, the data server 514 may form part of the authentication server 512.

In one embodiment, the data server 514 is the same server as data server 104 of system 100. In an alternative embodiment, the data server 104 and data server 514 are separate servers that communicate over a network, and data stored on the data server 104 is copied to the data server 514 at a predetermined frequency.

The authentication assistance units (not shown) comprise a processor, a computer readable medium, a validation indicator, a ticket reader, a valued identification reader, and a printer. The computer readable medium contains instructions stored therein that when executed by the processor facilitates: the reading of valued identification information from a piece of valued identification that is presented to the valued identification reader; the reading of ticket information from an event ticket that is presented to the ticket reader; and the printing of tickets. Each authentication assistance unit is in communication with authentication server 512 through network 510. The authentication assistance units can transmit read valued identification information and ticket information to the authentication server 512 and receive validation information from the authentication server 512. The validation indicator presents received validation information to the user of the authentication assistance unit. In operation, the authentication assistance units may be located at a event assistance wicket or adjacent to the ticket validation unit 504, and operated by event associates to assist ticketholders with problems using the ticket authentication system 500. The authentication assistance units may also print off new tickets if instructed by an operator. In a preferred alternative embodiment, the authentication assistance unit is a handheld wireless device, such as, for example, a Motorola MC55 Enterprise Digital Assistant with a bar code reader, magstripe reader, and near field communications transceiver.

In operation, the ticket validation unit 504 is located at the entrance to the event and the valued identification validation unit 502 is located at the event away from the entrance to the event. One or more ticket validation units 504 may be located at each entrance to the event and one or more valued identification validation units 502 may be located at the event. As further described below, this separation of the ticket validation unit 504 and the valued identification unit 502 facilitates the efficient validation of event tickets and entry into the event with minimum delay. In one embodiment, there is at least one valued identification validation unit 502 for every ticket validation unit 504 present at an event and preferably 1.5 valued identification validation units 502 for every ticket validation unit 504 present at an event.

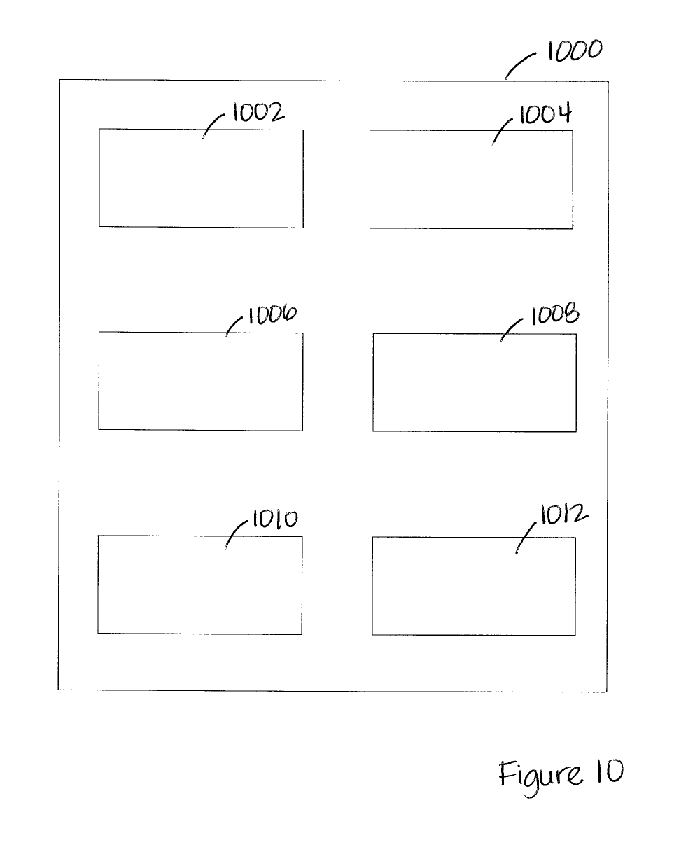

In an alternative embodiment, a ticketholder's mobile device may serve as a valued identification validation unit 502. Referring to FIG. 10, a mobile device 1000 is shown and generally comprises a display 1002 for presenting visual information to the ticketholder, an input device 1004 for receiving input from the ticketholder, a memory 1006, a processor 1008, a communication unit 1010, and a positioning unit 1012.

The memory 1006 contains statements and instructions stored therein that when executed by the processor 1008 facilitates the authentication of the ticketholder's valued identification information as further described below. The positioning unit 1012 determines the location of the mobile device 1000 using one or more Global Positioning System (GPS) receivers, cellular transceivers to triangulate the position of the mobile device between cell tower, Bluetooth transceivers to identify proximity of the mobile device 1000 to a Bluetooth device having a known location, and other methods of determining the location of a mobile device of known in the art. The communication unit 1010 communicates with the authentication server 512 to transmit one or more of authentication information, valued identification information or positioning information to the authentication server 512 and receive validation information from the authentication server 512. In the present embodiment, the mobile device 1000 is a personal digital assistant (such as, for example, a Blackberry™ smart phone having a GPS receiver and cellular transceiver), the positioning unit 1012 is a GPS receiver, and the communication unit 1010 is a cellular transceiver. In the alternative, the mobile device 1000 may be any mobile device capable of communicating with the authentication server 512 and determining its location known to one skilled in the art. In the further alternative, the positioning unit 1012 may be any technology known in the art to identify the location of a device. In the further alternative, the positioning unit 1012 and communication unit 1010 may be the same unit. In the further alternative, the mobile device 1000 may not comprises a positioning unit 1012.

In a further alternative embodiment, the original ticket vendor may exclude certain categories of tickets from the authentication process, such as, for example, tickets to corporate boxes and other areas of an event. Such tickets will not require validation of valued identification or valued identification information in order to permit the ticketholder entry to an event.

Ticket Authentication Method

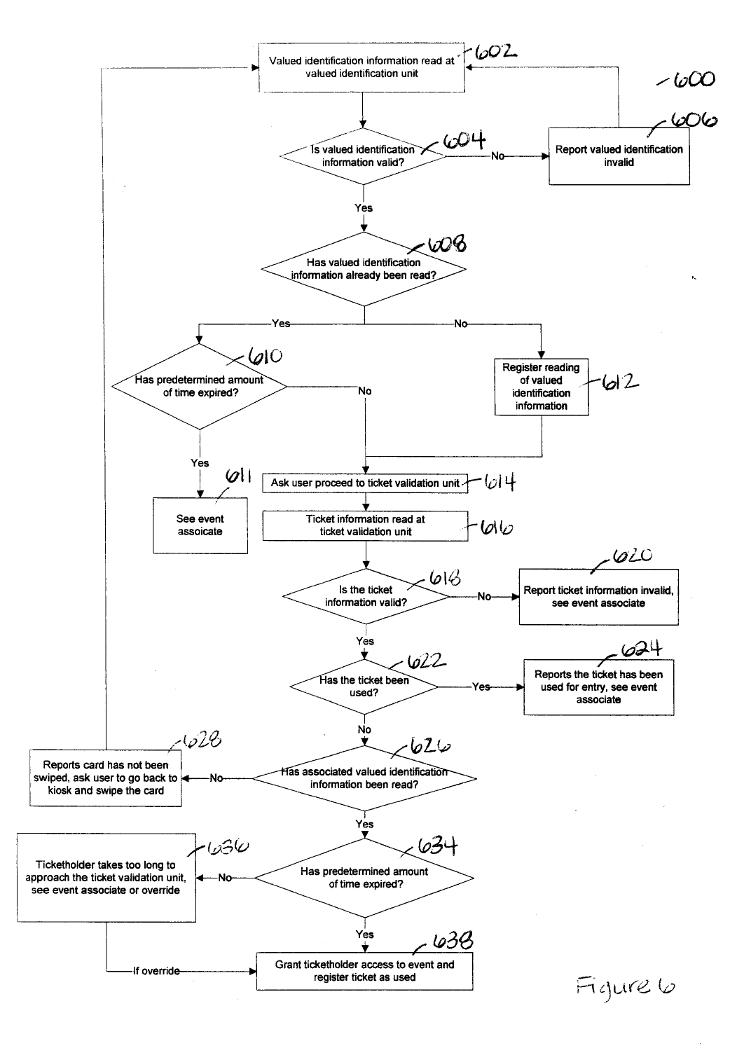

Referring to FIG. 6, a method 600 of authenticating a ticket at an event using system 500 is shown. In step 602, a ticketholder presents valued identification to the valued identification validation unit 502. The unit 502 reads valued identification information from the valued identification and transmits the information to the authentication server 512. The valued identification information may comprise account number information, owner information, expiration date information, service code information, verification information (i.e. PIN or card verification information, such as, for example, card verification code (CVC), card verification valued code (CVVC), card verification value (CVV), card security code (CSC), card verification data (CVD), verification code (V Code) or card code verification (CCV)), and other similar information known to one skilled in the art. In one embodiment, the valued identification information consists of account number information, owner information, and expiration date information.

In step 604, the authentication server 512 queries the data server 514 to match the read valued identification information to registered valued identification information stored in the data server 514. If the read valued identification information does not match any registered valued identification information stored in the data server 514, the method 600 proceeds to step 606. In step 606, the authentication server 512 informs the valued identification validation unit 502, and the valued identification unit 502 informs the ticketholder through the validation indicator, that the read valued identification is not valid. The method 600 then proceeds to step 602.

If in step 604 the read valued identification information matches any registered valued identification information stored in the data server 514, the method 600 proceeds to step 608 where the authentication server 512 queries the data server 514 as to whether the valued identification has already been read by a valued identification validation unit 502 at the present event. If the valued identification has already been read at the present event the method 600 proceeds to step 610, otherwise, the method 600 proceeds to step 612. In step 612, the authentication server 512 instructs the data server 514 to update the status of the registered valued identification to “read” and register the time that the ticket was read. In step 610, the authentication server 512 queries the data server as to whether a predetermined period of time has expired since the valued identification was first scanned by a valued identification validation unit 502. If the predetermined period of time has expired, the method 600 proceeds to step 611 where the authentication server 512 informs the valued identification validation unit 502, and the valued identification unit 502 informs the ticketholder through the validation indicator, to see an event associate, otherwise, the method proceeds to step 614.

In step 614, the valued identification validation unit 502 informs the ticketholder through the validation indicator that the ticketholders of all tickets registered with the read valued identification information are to proceed to a ticket validation unit 504 at the entrance to the event.

At step 616, the ticketholder presents a ticket to a ticket validation unit 504. The unit 504 reads the ticket information from the ticket and transmits the information to the authentication server 512. The ticket information may comprise ticket identification information, event information, seat information, and other information known o one skilled in the art. In one embodiment, the ticket information consists of ticket identification information containing a unique identifier for each ticket to an event. In step 618, the authentication server 512 queries the data server 514 as to whether the ticket information matches a valid ticket. If the ticket is not valid, the method 600 proceeds to step 620 where the authentication server 512 informs the ticket validation unit 504, and the ticket validation unit 504 informs the operator of the ticket validation unit 504 through the validation indicator, that the ticket is not valid. The ticketholder is then directed to see an event associate for further assistance.

If in step 618 the ticket is valid, the method 600 proceeds to step 622 where the authentication server 512 queries the data server 514 as to whether the ticket has already been used to access the event. If the ticket has already been read by a ticket validation unit 504, the method 600 proceeds to step 624 where the authentication server 512 informs the ticket validation unit 504, and the ticket validation unit 504 informs the operator of the ticket validation unit 504 through the validation indicator, that the ticket has already been used to access the event. The ticketholder is then directed to see an event associate for further assistance.

If in step 622 the ticket has not been used to access the event, the method proceeds to step 626 where the authentication server 512 queries the data server 514 as to whether the registered ticketholder valued identification associated with the ticket has been read by the valued identification validation unit 502. If the registered ticketholder valued identification has not been read, the method 600 proceeds to step 628 where the authentication server 512 informs the ticket validation unit 504, and the ticket validation unit 504 informs the operator of the ticket validation unit 504 through the validation indicator, that the registered ticketholder valued identification has not been read. The ticketholder is then directed to a valued identification validation unit 502.

If in step 626 the registered ticketholder valued identification has been read, the method 600 proceeds to step 634 where the authentication server 512 queries the data server 514 as to whether the registered valued identification associated with the read ticket has been read at a valued identification validation unit 502 within a predetermined period of time. If the predetermined period of time has expired, the method 600 proceeds to step 636 where the authentication server 512 informs the ticket validation unit 504, and the ticket validation unit 504 informs the operator of the ticket validation unit 504 through the validation indicator, the extent to which the predetermine period of time has expired. The operator of the ticket validation unit 504 may then permit the ticketholder to enter the event, proceeding to step 638, or direct the ticketholder to see an event associate. If in step 634 the predetermined period of time has not expired, the method 600 proceeds to step 638 where the ticketholder is granted access to the event and the authentication server 512 instructs the data server 514 to update the status of the ticket as “read”.

As previously described, the system 500 is designed such that the ticket validation unit 504 is located at the entrance to the event while the valued identification validation unit 502 is located at the event away from the entrance to the event. This separation facilitates the efficient validation of event tickets and the entry into the event with minimum delay. Valued identification is validated at a valued identification validation unit 502 prior to the ticketholder arriving at the entrance to the event. Any problems relating to the valued identification are addressed at the valued identification validation unit 502 without delaying ticketholders awaiting entry to the event at the event entrance. In addition, where the same registered ticketholder valued identification information is associated with more than one ticket, the registered ticketholder valued identification is only required to be read one time by a single ticket validation unit 504. Thus, in a group of ticketholders possessing tickets with the same registered ticketholder valued identification information, only one member of the group is required to present the registered ticketholder valued identification at the valued identification validation unit 502 while the remaining members of the group may proceed to the ticket validation unit 504 at the entrance to the event.

In an alternative embodiment, the method 600 may perform a preauthorization of a predetermined amount on the registered ticketholder valued identification associated with a ticket upon the presentation of the registered ticketholder valued identification to the valued identification validation unit 502. In this alternative embodiment, the authentication server 512 communicates the read valued identification information to a valued identification authorization system through a network along with a request for a preauthorization of a predetermined amount. In a preferred alternative embodiment, the predetermined amount is the price of the ticket. If the preauthorization request is denied by the valued identification authorization system, the authentication server 512 directs the data server 504 to mark the registered ticketholder valued identification information as invalid.

In an alternative embodiment, the mobile device 1000 described above may also function as a valued identification validation unit 502. The memory 1006 of the mobile device 1000 contains statements and instructions stored therein that when executed by the processor 1008 provide the following mobile valued identification method. The mobile valued identification method is identical to method 600 with the exception of step 602. In step 602, the ticketholder utilizes their mobile device 1000 to validate their valued identification information instead of a valued identification validation unit 502. The ticketholder utilizes their mobile device 1000 to communicate with the authentication server 512 and request validation of their valued identification information. The ticketholder sends mobile device identification information, positioning information and authentication information to the authentication server 512. The mobile device identification information may comprise a mobile phone number, a mobile PIN, mobile IP address, MAC address, or other identifier for uniquely identifying the ticketholder's mobile device 1000. The positioning information comprises the location of the mobile device 1000 or proximity of the mobile device 1000 to the event as determined by the positioning unit 1012. The authentication information may comprise a user name, password, valued identification information, contact information, or other information for authenticating the ticketholder known to one skilled in the art. The authentication server 512 confirms that the submitted mobile device identification information and authentication information to registered mobile device identification information and authentication information that have been previously registered by the ticketholder with the data server 504 in association with a ticket. In addition, the authentication server 512 confirms that the positioning information is within a predetermined minimum proximity to the event. If the confirmation fails, the authentication server 512 communicates with the mobile device 1000 informing the ticketholder of the failed confirmation. If the confirmation is successful, the authentication server 512 obtains the ticketholder's valued identification information registered with the date server 504 and proceeds to step 604 as described above. In the alternative, the mobile device 1000 prompts the ticketholder to perform the mobile valued identification method described above when the mobile device 1000 is within a predetermined minimum proximity to the event. In the further alternative, the positioning information is not communicated to or utilized by the authentication server. In the further alternative, the ticketholder communicates their valued identification information to the authentication server 512 using their mobile device 1000.

Secondary Market System

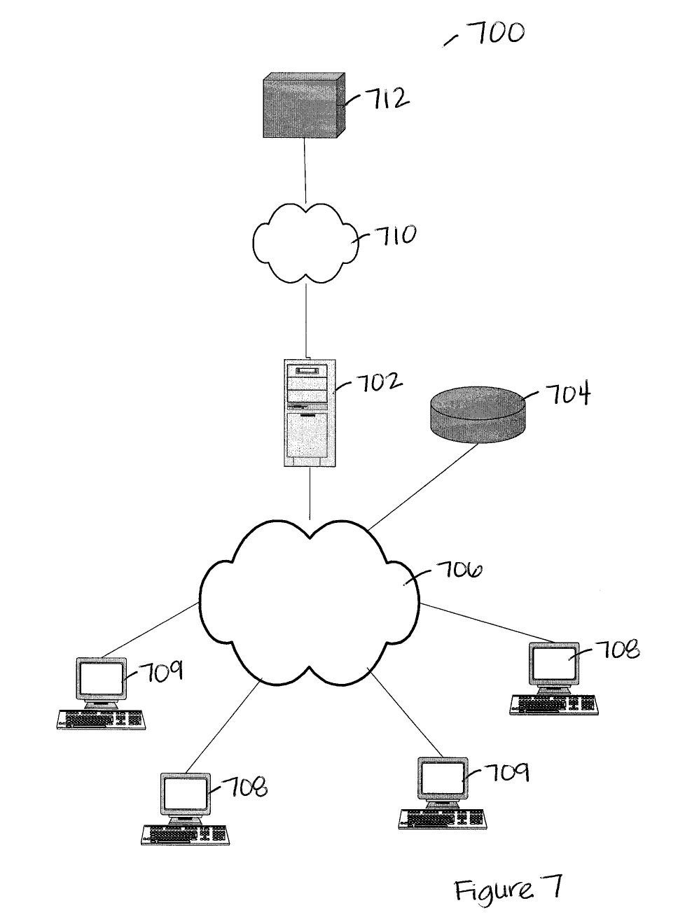

Referring to FIG. 7, a secondary market system 700 is shown. The system 700 enables registered original purchasers of event tickets to resell previously purchased tickets in a secondary market authorized by the original ticket vendors. The system 700 comprises a resale server 702, a data server 704, a network 706, user terminals 708, ticket vendors 709, a network 710, and a valued identification authorization system 712.

The resale server 702 comprises a processor and a computer readable medium (not shown). The computer readable medium contains instructions stored therein that when executed by the processor perform the secondary market method as further described below. The resale server 702 communicates with the data server 704, user terminals 708, and ticket vendors 709 through network 706, and the valued identification authorization system 712 through network 710.

The data server 704 comprises a processor and a computer readable medium (not shown). The computer readable medium contains instructions stored therein that when executed by the processor facilitate the management, communication, access and storage of data on the data server 704. The data consists of information respecting the identification, validity, availability, purchase, bidding, history, ownership and allocation of event tickets. In one embodiment, the data consists of user account information (i.e. user name, password, etc.), the status of each ticket (i.e. purchased, available for purchase, etc.), ticket information (i.e. ticket identification information, event information, seat information, etc.), ownership information (i.e. the original purchaser of each ticket, the ticketholder of each ticket, contact information of the original purchaser, contact information of the ticketholder, etc.), resale restrictions (i.e. tickets not permitted for resale, maximum or minimum resale prices, maximum number of tickets permitted to be resold by each seller, prohibited sellers, permitted sellers, etc.), valued identification information of the ticketholder of each ticket, bid information (i.e. desired event, desired price or price range, number of tickets, desired ticket type and/or location, etc.), and offer information (i.e. event, price or price range, ticket type and/or location, number of tickets, tickets sold together or separately, etc.). The data server 704 communicates with the resale server 702 through network 106. In the alternative, the data server 704 may communicate with the resale server 702 over a separate network from network 706. In the further alternative, the data server 704 may form part of the resale server 702.

In one embodiment, the data server 704 is the same server as data server 104 of system 100. In an alternative embodiment, the data server 104 and data server 704 are separate servers that communicate over a network, and data stored on the data server 104 is copied to the data server 704 at a predetermined frequency.

Users can access the resale server 702 through network 706 via a registration device, such as, user terminals 708 and ticket vendors 709. User terminals 708 may be a computer, cellular phone, personal digital assistant, gaming device or other communication device capable of communicating with a server through a network as known to one skilled in the art. The ticket vendors 709 may be a person or an automated telephone system and users may communicate with the ticket vendors 709 over the phone or in person at designated locations. In one embodiment, the resale server 702 hosts a website and sellers, purchasers and original ticket vendors communicate with the resale server 702 through the website via a web browser running on the user terminals 708 and ticket vendors 709.

The valued identification authorization system 712 contains information pertaining to valued identification and enables the authorization and charging of monetary amounts to an account associated with valued identification. The valued identification authorization system 712 communicates with the resale server 702 through network 710.

Secondary Market Method

The system 700 facilitates the secure resale of previously purchased tickets and ensures purchasers are provided with valid tickets and title thereto. The system 700 permits a registered original purchaser (“seller”) to sell a previously purchased ticket by either posting the ticket to the resale server 702 with an associated asking price or offering the ticket to a new purchaser or purchasers that have posted a bid for a ticket on the resale server 702. Similarly, the system 700 permits a new purchaser to purchase a previously purchased ticket by either posting a bid for the ticket to the resale server 702 along with an associated bid price or purchasing a ticket posted to the resale server by a seller.

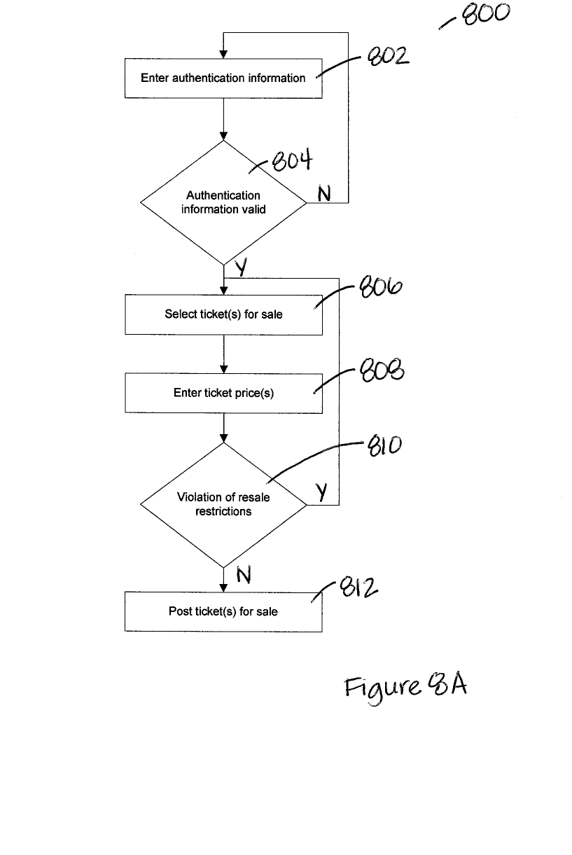

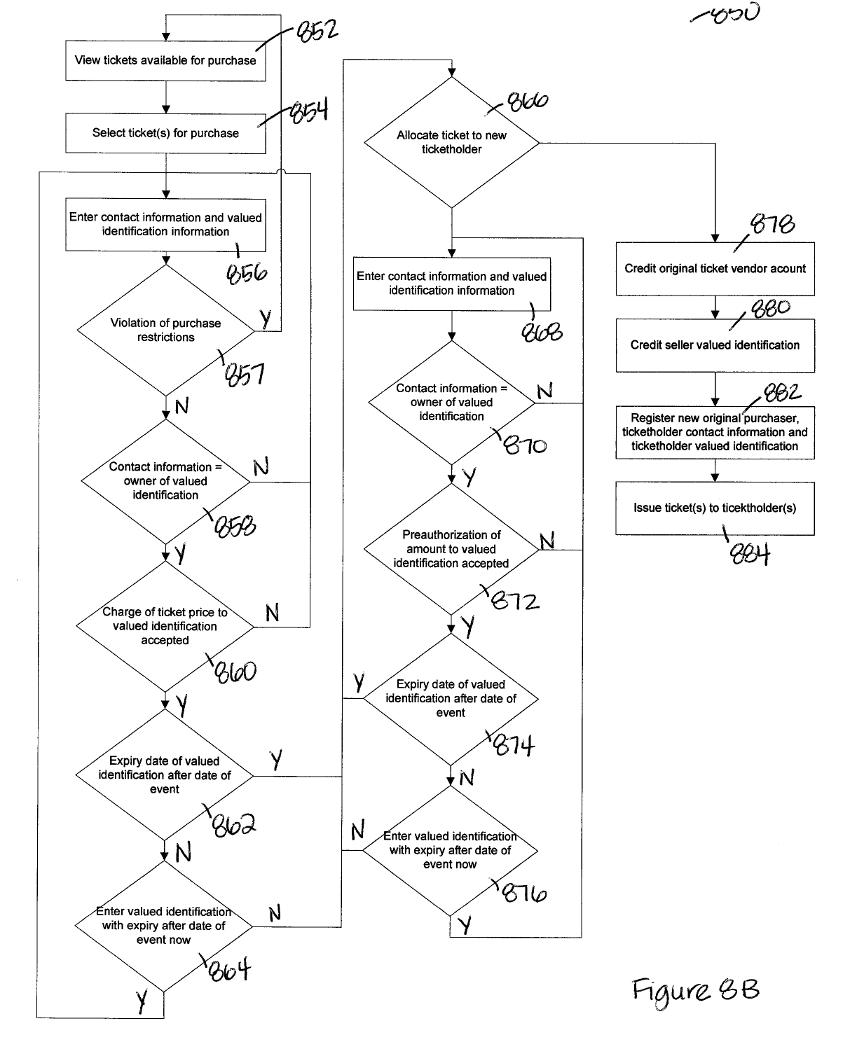

Referring to FIG. 8a, a method 800 of posting one or more previously purchased tickets for sale to the resale server 702 is shown. In step 802, a seller communicates to the resale server 702 through a user terminal 708 or ticket vendor 709 requesting the posting of one or more previously purchased tickets to the resale server 702. The resale server 702 then prompts the seller to enter authentication information to confirm the seller is the registered original purchaser of one or more tickets to the event. The authentication information may comprise one or more of the seller's account information, contact information, original valued identification information, and/or ticket information that has previously been registered with the resale server 702 and/or the ticket server 102 described above. In one embodiment, the authentication information consists of a user name and password. In step 804, the resale server 702 queries the data server 704 to authenticate the authentication information provided by the seller. If the authentication information is invalid the resale server 702 proceeds to step 802, otherwise, the resale server 702 proceeds to step 806.

In step 806, the resale server 702 prompts the seller to select one or more tickets that the seller desires to post for sale on the resale server 702. In step 808, the resale server 702 prompts the seller to enter offer information selected for each ticket selected in step 806. Offer information may comprise the event, price or price range, ticket type and/or location, number of tickets, tickets sold together or separately, and other information pertaining to and offer to sell one or more tickets known to one skilled in the art. In one embodiment, the offer information consists of the price and whether the tickets must be purchased together. In step 810, the resale server 102 queries the data server 704 to determine if the seller has violated any resale restrictions. If the seller has violated any resale restrictions the resale server 702 informs the seller and proceeds to step 806, otherwise, the resale server 702 proceeds to step 812. The resale restrictions may comprise: tickets not permitted for resale, maximum or minimum resale prices, maximum number of tickets permitted to be resold by each seller, prohibited sellers, permitted sellers and other restrictions known to one skilled in the art. In one embodiment, the resale restriction requires that the sale price of each ticket is greater than the original purchase price (i.e. face value) of the ticket.

In step 812, the resale server 702 posts the one or more tickets for sale on the website hosted by the resale server 702. Purchasers may view and purchase the tickets through the resale server 702 as further described below. Alternatively, in step 812, the resale server 702 may communicate offer information respecting the one or more tickets to potential purchasers over any electronic communication medium and in any format known to one skilled in the art, including without limitation, wired or wireless mediums, compressed or uncompressed formats, encrypted or unencrypted formats, email, facsimile, Short Message Service or text messages, Multimedia Messaging Service or multimedia messages, or instant messaging.

Referring to FIG. 8b, a method 850 of purchasing a previously purchased ticket posted on the resale server 102 is shown. In step 852, a purchaser communicates with the resale server 702 through a user terminal 708 or ticket vendor 709 requesting a listing of previously purchased tickets that are posted for sale for a particular event. The resale server 702 queries the data server 704 to acquire the listing and communicates the listing to the user terminal 708 or ticket vendor 709. The listing may be presented based upon the ticket price, original ticket price (i.e. face value), seat location, and/or other offer information. In step 854, the purchaser selects one or more tickets for purchase. If the offer information associate with the tickets requires that multiple tickets must be purchased together, the resale server 702 will only permit the purchaser to select the number of tickets specified. The resale server 702 then holds the selected tickets for a predetermined period during which other purchasers are prohibited from selecting the held tickets for purchase.

Steps 856 to 876 facilitate the purchase of the tickets by the purchaser and allocation of one or more tickets to one or more new ticketholders if desired by the purchaser. The operation of steps 856 to 876 are identical to and described in steps 206 to 226 ticket management method 200, respectively, with the exception that the ticket server 102, data server 104, network 106, user terminals 108, ticket vendors 109, network 110, and valued identification authorization system 112 are replaced with the resale server 702, data server 704, network 706, user terminals 708, ticket vendors 709, network 710, and valued identification authorization system 712, respectively.

In step 878, the resale server 702 credits the original ticket vendor with any service charges, transaction fees, commissions, profits above a certain price of the ticket, and/or other charges designated by the original ticket vendor. In one embodiment, the resale server 702 credits the original ticket vendor with a transaction fee and any profits greater than a certain amount of the original purchase price of the ticket. In the alternative, any of the above fees, charges, commissions, profits, or portions thereof, can be credited to the account of one or more third parties, such as a charity designated by the original ticket vendor and/or seller. In addition, the resale system 702 may automatically issue charitable tax receipts to the seller for amounts credited to the designated charities.

In step 880, the resale system 702, communicates with the valued identification authentication system 712 through network 710 and credits the account associated with the seller's registered valued identification with the purchase price of the tickets less any amounts deducted in step 878. In the alternative, the resale system 702 may deposit the amount in the seller's bank account, issue a cheque to the seller for the amount, register a credit of the amount with the original ticket vendor for future purchases of tickets, goods or services, or provide the amount to the seller in kind or as a credit in other manners known to one skilled in the art.

In step 882, the resale server 702 instructs the data server 704 to update the information associated with the purchased tickets. Specifically, for each purchased ticket the ticket server 702: (a) registers the purchaser as the original purchaser of the ticket; (b) registers the purchaser's contact information and valued identification; and (d) register's the ticketholder's contact information and valued identification information.

In step 884, the resale server 702 reissues the purchased tickets to the registered ticketholder of each ticket. In one embodiment, the ticket is an electronic ticket that is delivered to the registered ticketholder via email, text message, the website hosted by the ticket server 702, or other electronic communication method known to one skilled in the art. Optionally, the electronic tickets may be encrypted, as described above in relation to method 200, such that the ticket cannot be transferred to a third party. In the alternative, the ticket may be a physical ticket that is sent to the registered ticketholder via mail or courier, or picked up by the ticketholder at a specified location.

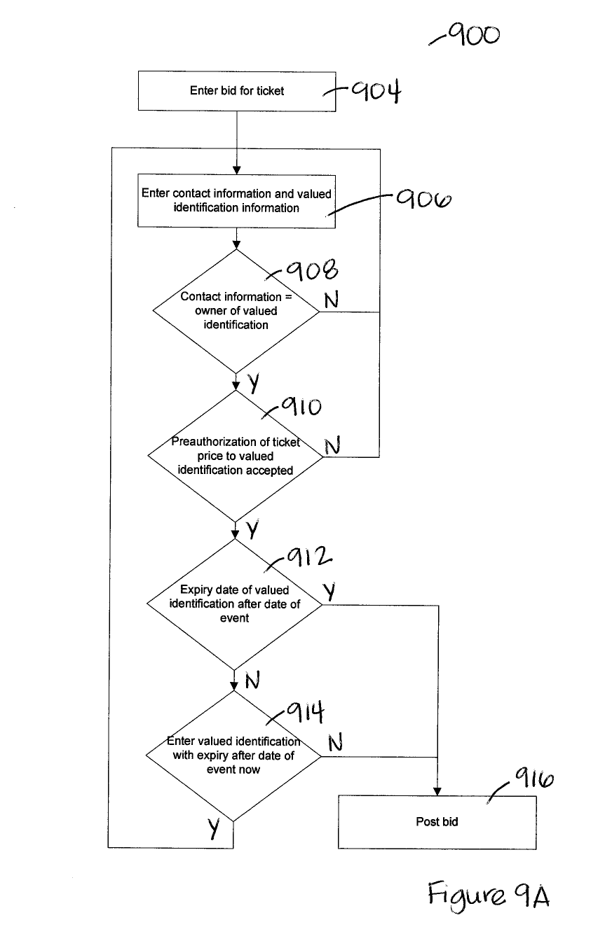

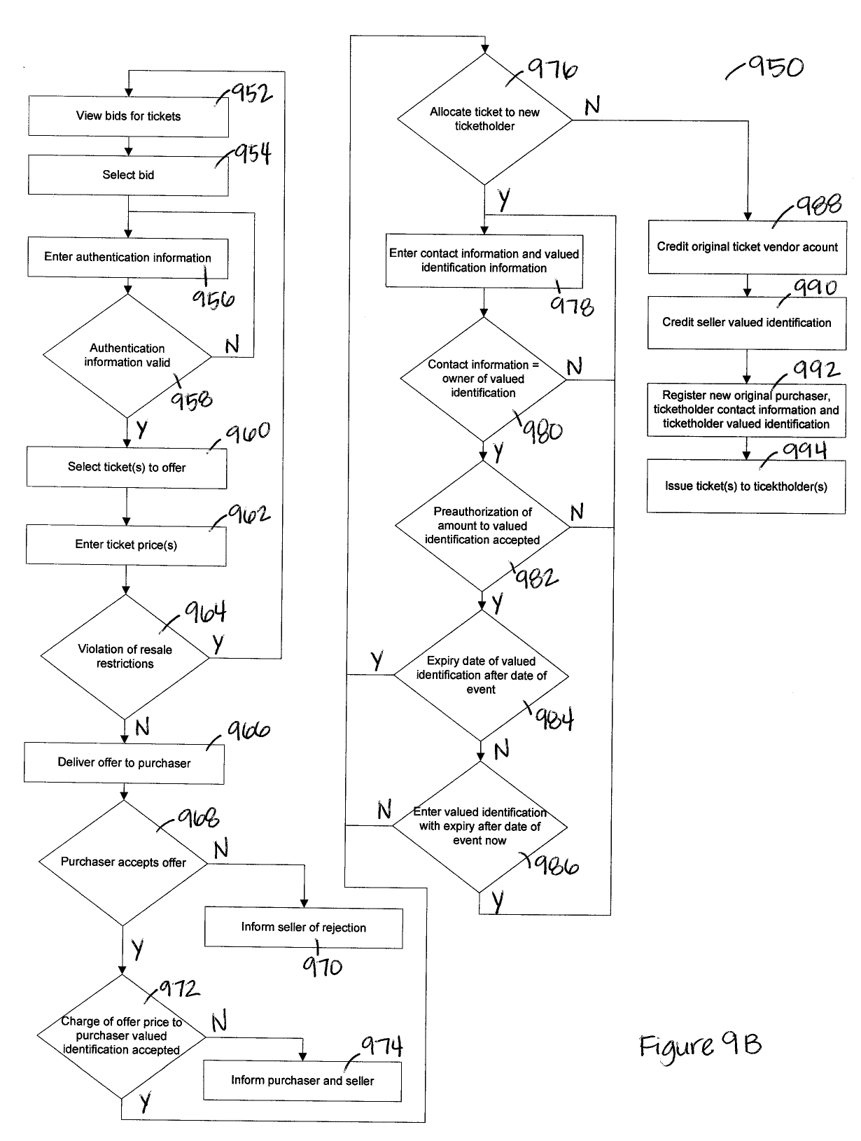

Referring to FIG. 9a, a method 900 of bidding for the purchase of one or more previously purchased tickets using system 700 is shown. In step 904, a purchaser communicates with the resale server 702 through a user terminal 708 or ticket vendor 709 and provides bid information for one or more tickets to an event. The bid information may comprise a desired event, a desired price, price range (i.e. maximum price), or price category (i.e. event seats having a face value in a specified price range), desired areas or seat locations, time limit for a bid, number of tickets, and other information for particularizing a bid for a type of ticket. In one embodiment, the bid information consists of a desired price category, maximum price, and a time limit for which the bid is valid. The desired areas or seat locations may be selected through an interactive graphical event area and seating map made available on the website hosted by the resale server 702.

In step 906, the resale server 702 prompts the purchaser to enter the purchaser's contact information and valued identification information, in the same form as described above in step 206 of method 200. In step 908, the resale server 702 compares the purchaser's contact information to the ownership information of the purchaser's valued identification. If the purchaser's contact information does not match the ownership information of the purchaser's valued identification the resale server 702 informs the purchaser and proceeds to step 906, otherwise, the resale server 702 proceeds to step 910. In step 910, the resale server 702 communicates the purchaser's valued identification information to the valued identification authorization system 712 through network 710 along with a preauthorization request for the price bid for the tickets. If the preauthorization request is denied by the valued identification authorization system 712, the resale server 702 informs the purchaser and proceeds to step 906, otherwise, the resale server 702 proceeds to step 912.

In step 912, the resale server 702 compares the expiry date of the purchaser's valued identification to the date of the event. If the expiry date of the purchaser's valued identification is after the date of the event, the resale server 702 proceeds to step 916, otherwise, the resale server 702 proceeds to step 914. In step 914, the resale server 702 informs the purchaser that prior to the date of the event the purchaser must register valued identification with the resale server 702 having an expiry date after the date of the event. The purchaser is prompted to either enter new valued identification having an expiry date after the date of the event or indicate that the purchaser will enter such valued identification at a later time prior to the date of the event (i.e. by selection of a check box or other manner of indication known to one skilled in the art). If the purchaser selects the entry of new valued identification, the resale server 702 proceeds to step 906, otherwise, the resale server 702 proceeds to step 916.

In step 916, the resale server 702 posts the bid on the website hosted by the resale server 702. Sellers may view the bids and offer previously purchased tickets for sale to bidders through the resale server 702 as further described below. The purchaser may submit one bid or multiple bids for one or more tickets or categories of tickets (i.e. price range, locations, etc.). Alternatively, in step 916, the resale server 702 may communicate the bid to potential purchasers over any electronic communication medium and in any format known to one skilled in the art, including without limitation, wired or wireless mediums, compressed or uncompressed formats, encrypted or unencrypted formats, email, facsimile, Short Message Service or text messages, Multimedia Messaging Service or multimedia messages, or instant messaging.

Referring to FIG. 9b, a method 950 of offering a previously purchased ticket to fulfill a bid for the purchase of a ticket is shown. In step 952, a seller communicates with the resale server 702 through a user terminal 708 or ticket vendor 709 requesting a listing of the bids for tickets for a particular event. The resale server 702 queries the data server 704 to acquire the listing and communicates the listing to the user terminal 708 or ticket vendor 709. In step, 954 the seller selects a bid of a purchaser for which the seller desires to offer one or more of the seller's tickets for sale.

In step 956, the resale server 702 prompts the seller to enter authentication information to confirm the seller is the registered original purchaser of one or more tickets to the event. The authentication information may be one or more of the seller's user account information, original purchaser contact information, original purchaser valued identification information, and/or ticket information that has previously been registered with the resale server 702 and/or the ticket server 102 of system 100 described above. In one embodiment, the authentication information consists of a user name and password. In step 958, the resale server 702 queries the data server 704 to authenticate the authentication information provided by the seller. If the authentication information is not valid the resale server 702 proceeds to step 956, otherwise, the resale server 702 proceeds to step 960.

In step 960, the resale server 702 prompts the seller to select one or more tickets that the seller desires to offer for sale to the purchaser. In step 962, the resale server 702 prompts the seller to enter offer information for each ticket selected in step 960. Offer information may comprise the event, price or price range, ticket type and/or location, number of tickets, tickets sold together or separately, and other information pertaining to and offer to sell one ore more tickets known to one skilled in the art. In one embodiment, the offer information consists of the price and whether the tickets must be purchased together. In step 964, the resale server 102 queries the data server 704 to determine if the seller has violated any resale restrictions, in the same form as described above in step 810 of method 800. If the seller has violated any resale restrictions the resale server 702 informs the seller and proceeds to step 960, otherwise, the resale server 702 proceeds to step 966.

In step 966, the resale server 702 communicates the seller's offer information to the purchaser. In step 968, the purchaser elects to accept the offer or reject the offer by communicating a response to the resale server 702. If the purchaser rejects the offer, the resale server 702 proceeds to step 970 and informs the seller that the offer was rejected. If the purchaser accepts the offer, the resale server 702 proceeds to step 972 and communicates the purchaser's valued identification information to the valued identification authorization system 712 through network 710 along with a request to charge the price of the tickets offered by the seller. If the charge request is denied by the valued identification authorization system 712, the resale server 702 proceeds to step 974 and informs the purchaser and/or seller, otherwise, the resale server 702 proceeds to step 976. Where the seller has made offers for the same tickets to multiple purchasers and one of the purchasers has accepted an offer by the seller, the resale server 702 prevents the other purchasers from selecting the purchase of the tickets in step 968 and sends a communication to the other purchasers informing them that the seller's offer has been withdrawn.

Steps 976 to 994 permit the purchaser to allocate one or more purchased tickets to one or more new ticketholders, facilitate the crediting of designated portions of the purchase price to the original ticket vendor and/or seller, register the purchaser and new ticketholders in association with the purchased tickets, and reissue the purchased tickets to the new ticketholders. The operation of steps 976 to 994 are identical to and are described in steps 866 to 884, respectively, in relation to method 850.

In a further alternative embodiment, in step 884 of method 800 and step 994 of method 900, the registered original purchaser is prompted to select one of the following methods of delivery for the purchased tickets: 1) delivery of the physical tickets by courier or mail; 2) pickup of physical tickets at location, for example, at a will call window; or 3) electronic delivery of electronic tickets. Optionally, the purchaser may select a different method of delivery for each ticket. Where electronic delivery is selected, the resale server 702 will delay electronic delivery of the electronic tickets to the registered ticketholders until a predetermined period before the start of the event, such as, for example, 24 hours prior to the start of the event. In the alternative, the predetermined period may be configure to be any period prior to the start of the event. In the further alternative, the electronic delivery of electronic tickets may be delayed until the valued identification associated with each ticket is subsequently verified at a predetermined minimum period prior to the start of the event as further described below. Amongst other benefits, the delayed delivery of electronic tickets to the predetermined period places an additional impediment to ticketholders attempting to resell their electronic tickets using unauthorized channels.

The resale server 702 also provides historical information of tickets posted for sale, bids for tickets, offers to bids, and completed sales of tickets on the resale server 702.

Once the ticket has be resold through any of processes 800, 850, 900 and 950, the new purchaser and allocated ticketholders may manage the purchased tickets through the ticket management system 100 described above. At any point prior to the completion of the sale, a purchaser may cancel any of the purchaser's bids posted on the ticket server 102 and a seller may cancel any of the seller's offers posted on the ticket server 102.

In an alternative embodiment, the secondary market system 700 may service a plurality of secondary markets for multiple events or the same event. For example, the original ticket vendor may specify a general group of tickets that can be resold in a general secondary market and a specific group of tickets that can only be resold in a specific secondary market, such as, tickets that may be resold only among fan club members, concierge clubs (for example, American Express™ Front of the Line™), or other designated groups.

In a further alternative embodiment, the resale server 702 is configured to present purchasers with the view that the purchaser can expect to see from the seat that the purchaser is considering purchasing. The data server 704 stores a plurality of graphical images (each a “seat view”) depicting views at the event and registers the seat views with the associated ticket for the event. In step 852 of method 800 and step 966 of method 966, the resale server 702 queries the data server 704 to determine if a seat view is associated with the ticket. If a seat view is available, the resale server 702 communicates the seat view, or link to the seat view, to the purchaser. Before purchasing the ticket, the purchaser may select the seat view associated with the ticket to get a sense of the view from the seat or area for which the ticket relates. In one embodiment, the same seat view may be used for a predefined group of tickets. For example, the tickets relating to a block of seats at an event could have the same associated seat view representative of the view from the center seat of the block of seats. In the alternative, the seat view representative of the view from any location within the block of seats may be associated with all of the tickets in the block of seats. In the further alternative, a distinct seat view may be association with each ticket. In a further alternative embodiment, the resale server 702 permits a user access the seat view of tickets listed in the history of tickets sold through the system 700.

In a further alternative embodiment, a seller may request the resale server 702 to automatically send updates to the seller reporting new high bids posted to the system. Similarly, a purchaser may request the resale server 702 to automatically send updates to the purchaser reporting new low offers posted to the system. The seller and purchaser may request the ticket server 702 to restrict the updates to report bids and offers respecting tickets in a particular category, such as, price category, location of associated seat at the event, or other criteria know to one skilled in the art. The updates may also comprise information on previous bids and offers, the next highest or lowest bids and offers, ticket information, purchase restrictions, and other relevant information to the ticket.

In a further alternative embodiment, in step 812 the resale server 702 determines if the one or more previously purchased tickets posted for sale to the resale server 702 satisfy the bid information of any of the bids submitted to the resale server 702 in accordance with method 900. For each bid that is satisfied by one or more of the tickets posted for sale, the resale server 702 communicates to the purchaser submitting the bid the particulars of those tickets. The purchaser may then purchase the tickets in accordance with method 850. Similarly, in step 916 the resale server 702 determines if one or more tickets posted for sale to the resale server 702 satisfy the bid information of the bid submitted by the purchaser. For each of the one or more tickets that satisfy the bid, the resale server 702 communicates to the purchaser submitting the bid the particulars of those tickets. The purchaser may then purchase the tickets in accordance with method 850.

In a further alternative embodiment, the system 700 may permit a third party agent, such as a concierge, to purchase tickets on behalf of a purchaser. The third party agent purchase tickets in the identical manner described above except in step 856 of method 850 and step 906 of method 900, the resale server 702 permits the third party agent to enter account information that uniquely identifies the third party agent. All ticket purchases for which the third party agent participates using the system 700 are recorder on the data server 704. The original ticket vendor may then offer various forms of compensation to the third party agent depending on the number or value of ticket purchases for which the agent participates.

In a further alternative embodiment, the system 500 and system 700 are configured to permit a ticketholder in attendance at an event (“segmented event”) comprising multiple games, acts, parts or segments (each an “event segment”) to leave the segmented event, resell tickets to one or more of the remaining event segments of the segmented event to one or more purchasers, and authenticate the resold tickets to the event segments.

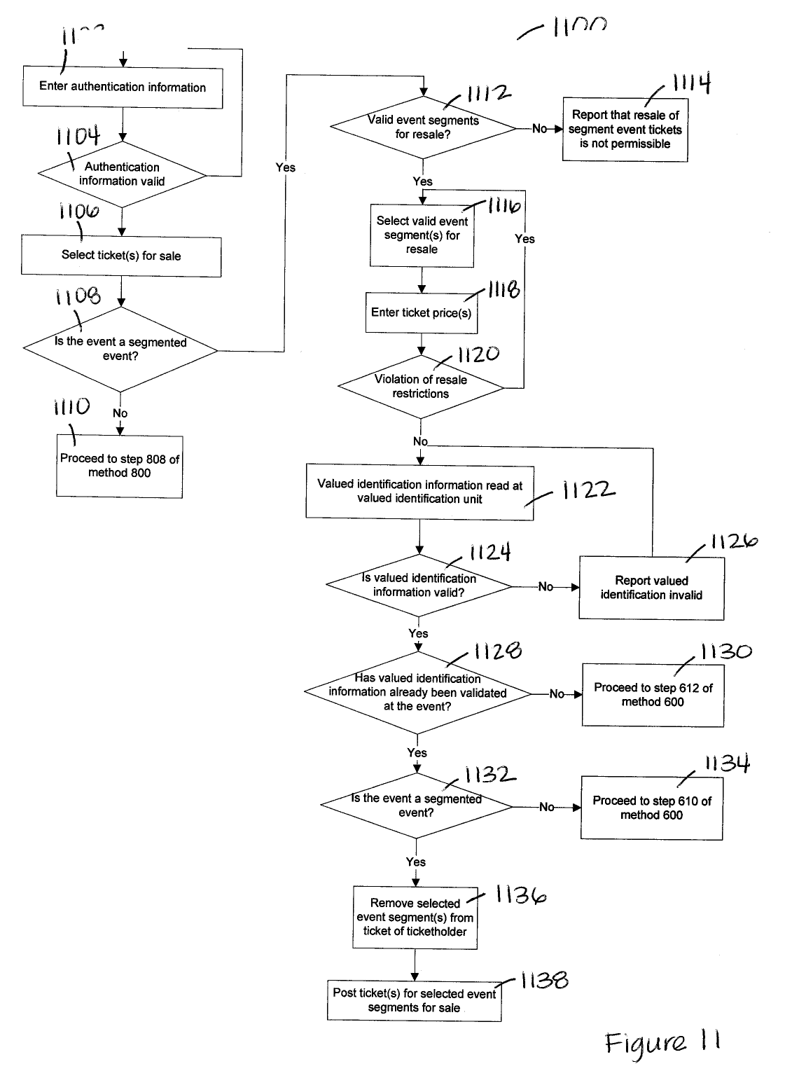

Referring to FIG. 11 a method 1100 of offering for resale one or more tickets to one or more events segments of a segmented event is shown. In steps 1102 to 1106 a seller communicates with the resale server 702 through a user terminal 708 or ticket vendor 709 and selects one or more tickets to the event that the seller desires to resell. Steps 1102 to 1106 are identical to steps 802 to 806 of method 800. These steps may be performed during (a) the purchase of the tickets by the seller through the ticket management system 100 or the secondary market system 700, or (b) after the purchase of the tickets by the seller either prior to or during a segmented event.

In step 1108, the resale server 702 queries the data server 704 to determine if the event associated with the selected tickets is a segmented event. If the event is a segmented event, the method 1100 proceeds to step 1112, otherwise, the method 1100 proceeds to step 1110 where the method 1100 proceeds step 808 of method 800 and continues with method 800 until completion.

In step 1112, the resale server 702 queries the data server 704 to determine if there are any valid event segments for which the selected tickets are permitted to be resold. If none of the event segments are valid, the method 1100 proceeds to step 1114 where the resale server 702 informs the seller that resale of tickets for the segmented event is not permitted. However, if any of the event segments are valid, the method 1100 proceeds to step 1116. The validation of the event segments comprises determining which event segments have not completed, whether the seller is authorized to resell tickets to the event segments, and whether the ticket is authorized for resale (for example, complimentary tickets may be precluded from resale).

In step 1116 the resale server 702 communicates to the seller the valid event segments that the seller is permitted to resell and prompts the seller to select the event segments for which the seller desires to resell tickets. Once the seller selects the event segments, the method 1100 proceeds to step 1118 where the resale server 702 prompts the seller to enter offer information respecting the sale of tickets for the selected event segments. Offer information may comprise the event segment, price or price range, ticket type and/or location, number of tickets, tickets sold together or separately, and other information pertaining to and offer to sell one or more tickets known to one skilled in the art. In one embodiment, the offer information consists of the price and whether the tickets must be purchased together.

The method 1100 then proceeds to step 1120 where the resale server 702 queries the data server 704 to determine if the seller has violated any resale restrictions. If the seller has violated any resale restrictions the resale server 702 informs the seller of the violation and proceeds to step 1116, otherwise, the resale server 702 proceeds to step 1122. The resale restrictions may comprise: tickets not permitted for resale, maximum or minimum resale prices, maximum number of tickets permitted to be resold by each seller, prohibited sellers, permitted sellers and other restrictions known to one skilled in the art. In one embodiment, the resale restriction requires that the sale price of each ticket is greater than the original purchase price (i.e. face value) of the ticket prorated by the number of event segments in the event.

In step 1122, the seller presents valued identification to the valued identification validation unit 502. The unit 502 reads valued identification information from the valued identification and transmits the information to the authentication server 512. The method 1100 then proceeds to step 1124 where the authentication server 512 queries the data server 514 to match the read valued identification information to registered valued identification information stored in the data server 514. If the read valued identification information does not match any registered valued identification information stored in the data server 514, the method 1100 proceeds to step 1126, where the authentication server 512 informs the seller through the valued identification validation unit 502 that the read valued identification is not valid. The method 1100 then proceeds to step 1122.

If in step 1124 the read valued identification information matches any registered valued identification information stored in the data server 514, the method 1100 proceeds to step 1128 where the authentication server 512 queries the data server 514 as to whether the valued identification has already been validated at the present event in accordance with method 600. If the valued identification has already been validated at the present event the method 1100 proceeds to step 1132, otherwise, the method 1100 proceeds to step 1130 where the method 1100 proceeds to step 612 of method 600 and continues with method 600 until completion.

In step 1132, the authentication server 512 queries the data server 514 to determine if the current event is a segmented event. If the current event is a segmented event, the method 1100 proceeds to step 1136, otherwise, the method 1100 proceeds to step 1134 where the method 1100 proceeds to step 610 of method 600 and continues with method 600 until completion.

In step 1136, the resale server 702 communicates with the data server 704 to cancel the seller's ticket such that the seller is no longer permitted to access the event with his or her ticket. The method 1100 then proceeds to step 1138 where the resale server 702 posts the one or more tickets for the selected event segments for sale on the website hosted by the resale server 702. Purchasers may view and purchase the tickets through the resale server 702 in the manner described above in method 850. A purchaser of the tickets for any of the selected event segments may then use the ticket to access the event for the event segment in the manner described above in method 600. Alternatively, in step 1138, the resale server 702 may communicate offer information respecting tickets to the selected event segments to potential purchasers over any electronic communication medium and in any format known to one skilled in the art, including without limitation, wired or wireless mediums, compressed or uncompressed formats, encrypted or unencrypted formats, email, facsimile, Short Message Service or text messages, Multimedia Messaging Service or multimedia messages, or instant messaging.

In the alternative, in step 1136 the resale server 702 does not cancel the seller's ticket, instead, the resale server 702 communicates with the data server 704 to remove the selected event segments for resale from the ticket information associated with the seller's ticket such that the seller can no use the ticket to access the event for the selected event segments, however, the seller may use the ticket to access the event for any remaining event segments that have not been selected for resale. In the further alternative, step 1136 occurs after step 1138, such that the seller's ticket or the selected event segments are not cancelled or removed from the ticket information associated with the seller's ticket until one or more tickets to the selected event segments are resold to a purchaser.

Optionally, in order to assist in ensuring that an individual entering the segmented event with an event ticket exits the event prior to the resale of event segments under the ticket, the seller may be required to allocate the event tickets to the individuals that will be using the tickets to enter the segmented event when (a) the seller purchases the tickets or (b) after the purchase of the tickets, the seller indicates a desire to resell event segments under the tickets. In this manner, a ticket to event segments of a segmented event cannot be resold until the valued identification of the individual attending the event is presented at a valued identification validation unit 502 outside of the segmented event.

In the further alternative, at step 1118 of method 1100, the seller may indicate that the seller will enter a ticket price for the tickets each segmented event at a later time. The method 1100 will delay the posting tickets to the selected event segments for resale until the seller has provided valid ticket prices in accordance with steps 1118 and 1120 of method 1100. For example, during purchase of event tickets to segmented event, the seller may setup selected event segments for resale upon the departure of the seller from the segmented event, however, the seller may desire to defer specifying a resale price for the tickets until the seller has the opportunity to assess the secondary market for the tickets either prior to or during the event.

In a further alternative embodiment, instead of presenting valued identification to a valued identification unit 502 in step 1124, the seller utilizes his or her mobile device 1000 to initiate the resale of selected event segments. Specifically, in step 1124 the seller sends mobile device identification information, positioning information and authentication information to the authentication server 512 upon exiting the event. The mobile device identification information may comprise a mobile phone number, a mobile PIN, mobile IP address, MAC address, or other identifier for uniquely identifying the ticketholder's mobile device 1000. The positioning information comprises the location of the mobile device 1000 or proximity of the mobile device 1000 to the event as determined by the positioning unit 1012. The authentication information may comprise a user name, password, valued identification information, contact information, or other information for authenticating the ticketholder known to one skilled in the art.

The authentication server 512 confirms that the submitted mobile device identification information and authentication information to registered mobile device identification information and authentication information that have been previously registered by the ticketholder with the data server 504 in association with a ticket. In addition, the authentication server 512 confirms that the positioning information indicates that the seller has exited the event. If the confirmation fails, the authentication server 512 communicates with the mobile device 1000 informing the seller of the failed confirmation. If the confirmation is successful, the authentication server 512 obtains the seller's valued identification information registered with the date server 504 and proceeds to step 1128.

In the alternative, the mobile device 1000 prompts the ticketholder to perform the mobile valued identification method described above when the mobile device 1000 is within a predetermined minimum proximity to the event. In the further alternative, the positioning information is not communicated to or utilized by the authentication server. In the further alternative, the ticketholder communicates their valued identification information to the authentication server 512 using their mobile device 1000.

While particular embodiments of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

1. A method for reducing the unauthorized resale of tickets to an event comprising:
(a) reading valued identification information (“read valued identification information”) from one or more valued identifications at one or more locations at the event away from the entrance of the event and communicating the read valued identification information to a server;
(b) reading ticket information from a ticket at the entrance of the event and communicating the ticket information to the server;
(c) determining by the server whether to grant access to the event to a ticketholder of the ticket by determining if:
(i) the ticket information is valid; and
(ii) the read valued identification information comprises valued identification information registered with the server in association with the ticket information (the “registered valued identification”); and
(d) communicating by the server to the entrance of the event whether to grant access to the event to the ticketholder.

2. The method according to claim 1 wherein determining if the ticket information is valid comprises verifying that the ticket information matches ticket information registered with the server for the event.

3. The method according to claim 2 wherein determining by the server whether to grant access to the event to a ticketholder of the ticket further comprises determining whether a predetermined period of time has not expired since the registered valued identification information was first read at a location at the event away from the entrance to the event.

4. The method according to claim 1 wherein:
(a) the method further comprises determining by the server if the read valued identification information is valid; and
(b) determining by the server whether to grant access to the event to a ticketholder of the ticket further comprises determining if the registered valued identification information has been validated.

5. The method according to claim 4 further comprising communicating by the server to the location at the event away from the entrance to the event where the read valued identification information was read whether the read valued identification information is valid.

6. The method according to claim 4 wherein determining by the server if the read valued identification information is valid comprises verifying that the read valued identification information matches valued identification information registered with the server in association with one or more tickets.

7. The method according to claim 4 wherein determining if the read valued identification information is valid further comprises determining whether a preauthorization requested prior to the event from a valued identification authorization system for charging a predetermined monetary amount to an account associated with the read valued identification information was granted.

8. The method according to claim 4 wherein determining if the read valued identification information is valid further comprises requesting from a valued identification authorization system preauthorization for charging a predetermined monetary amount to an account associated with the read valued identification information and verifying that the preauthorization is granted.

9. The method according to claim 1 wherein the registered valued identification information comprises valued identification from a plurality of valued identifications.

10. The method according to claim 9 wherein:
(a) the registered valued identification information comprises primary valued identification information and secondary valued identification information; and
(b) determining by the server whether to grant access to the event to a ticketholder of the ticket further comprises determining if the secondary valued identification has been used to grant access to more than a predetermined number of tickets.

11. A system for reducing the unauthorized resale of tickets to an event comprising:
(a) a valued identification validation unit for placement at the event away from the entrance of the event, the valued identification validation unit comprising a first processor, a valued identification reader that is communicative with the first processor, and a first computer readable medium that is communicative with the first processor and that comprises instructions that when executed by the first processor cause the valued identification unit to read valued identification information (“read valued identification information”) from a valued identification presented to the valued identification reader and to communicate the read valued identification information to a server;
(b) a ticket validation unit for placement at the entrance of the event, the ticket validation unit comprising a second processor, a ticket reader that is communicative with the second processor, and a second computer readable medium that is communicative with the second processor and that comprises instructions that when executed by the second processor cause the ticket validation unit to read ticket information from a ticket presented to the ticket reader and to communicate the ticket information to the server;
(c) wherein the server comprises a third processor and a third computer readable medium that is communicative with the third processor, the third computer readable medium comprising instructions that when executed by the third processor cause the server to:
(i) receive valued identification information from the valued identification validation unit;
(ii) receive ticket information from the ticket validation unit;
(iii) determine whether to grant access to the event to a ticketholder of the ticket by determining if:
(1) the ticket information is valid; and
(2) the read valued identification information comprises valued identification information registered with the server in association with the ticket information (the “registered valued identification”); and
(iv) communicate to the ticket validation unit whether to grant access to the event to the ticketholder.

12. The system according to claim 11 wherein determining if the ticket information is valid comprises verifying that the ticket information matches ticket information registered with the server for the event.

13. The system according to claim 12 wherein determining whether to grant access to the event to a ticketholder of the ticket further comprises determining whether a predetermined period of time has not expired since the registered valued identification information was first read at a location at the event away from the entrance to the event.

14. The system according to claim 11 wherein:
(a) the instructions that comprise the third computer readable medium when executed further cause the server to determine if the read valued identification information is valid; and
(b) determining whether to grant access to the event to a ticketholder of the ticket further comprises determining if the registered valued identification information has been validated.

15. The system according to claim 14 wherein the instructions that comprise the third computer readable medium when executed further cause the server to communicate to the valued identification validation unit where the read valued identification information was read, and the instructions that comprise the first computer readable medium when executed further cause the ticket validation unit to display, whether the read valued identification information is valid.

16. The system according to claim 14 wherein determining if the read valued identification information is valid comprises verifying that the read valued identification information matches valued identification information registered with the server in association with one or more tickets.

17. The system according to claim 14 wherein determining if the read valued identification information is valid further comprises determining whether a preauthorization requested prior to the event from a valued identification authorization system for charging a predetermined monetary amount to an account associated with the read valued identification information was granted.

18. The system according to claim 14 wherein determining if the read valued identification information is valid further comprises requesting from a valued identification authorization system preauthorization for charging a predetermined monetary amount to an account associated with the read valued identification information and verifying that the preauthorization is granted.

19. The system according to claim 11 wherein the registered valued identification information comprises valued identification from a plurality of valued identifications.

20. The system according to claim 19 wherein:
(a) the registered valued identification information comprises primary valued identification information and secondary valued identification information; and
(b) determining by the server whether to grant access to the event to a ticketholder of the ticket further comprises determining if the secondary valued identification has been used to grant access to more than a predetermined number of tickets.

21.-82. (canceled)
